(19) United States
(12) Patent Application Publication
(10) Pub. No.: US 2018/0174446 A1
(43) Pub. Date: Jun. 21, 2018

(54) SYSTEM AND METHOD FOR TRAFFIC VIOLATION AVOIDANCE

(71) Applicant: Kevin Sunlin Wang, Flushing, NY (US)

(72) Inventor: Kevin Sunlin Wang, Flushing, NY (US)

(21) Appl. No.: 15/898,023

(22) Filed: Feb. 15, 2018

Related U.S. Application Data
(63) Continuation-in-part of application No. 15/019,862, filed on Feb. 9, 2016, now Pat. No. 9,928,735.
(60) Provisional application No. 62/234,279, filed on Sep. 29, 2015.
(60) Provisional application No. 62/150,118, filed on Apr. 20, 2015.
(60) Provisional application No. 62/113,922, filed on Feb. 9, 2015.

(51) Int. Cl. G08G 1/01; G08G 1/015; G06Q 50/26

(52) U.S. Cl. CPC G08G 1/0133; G08G 1/096716; G06Q 50/265; G08G 1/015

(57) ABSTRACT

A system and method for providing traffic violation avoidance guidance by categorizing traffic data into data types or user types corresponding to one another, the data and user types including one of commercial vehicle, non-commercial vehicle, vehicle type, vehicle plate type, motorcyclist, cyclist, or pedestrian, and generating notifications of potential traffic violations based on the user's location and type. A summary of differences between a first set of traffic rules associated with a first location and a second set of traffic rules associated with a second location may be generated based on the data type or the user type. The system and method may also analyze traffic data to predict potential traffic violations based on a user's location and type, and to provide a notification regarding the potential traffic violations to the user through a user engagement panel associated with a user's remote computing device.

### CROSS-REFERENCE TO RELATED APPLICATIONS

The present application is a continuation-in-part of U.S. patent application Ser. No. 15/019,862, filed on Feb. 9, 2016, which claims priority under 35 U.S.C. 119(e) to U.S. Provisional Application No. 62/234,279, filed on Sep. 29, 2015, U.S. Provisional Application No. 62/150,118, filed on Apr. 20, 2015, and U.S. Provisional Application No. 62/113,922, filed on Feb. 9, 2015, the contents of which are hereby incorporated by reference herein in their entireties.

### BACKGROUND

1. Technical Field of Invention

The embodiments herein generally relate to avoidance of traffic violations, and more particularly, to a method and system for gathering and analyzing traffic violation related data to predict or infer potential traffic violations for a user and alert the user of the potential traffic violations.

2. Description of Related Art

In many jurisdictions throughout the world, the manner in which people operate vehicles on the public roadways is highly regulated. These regulations are in place primarily for the purpose of public safety and for ensuring an orderly flow of traffic.

Some traffic laws and regulations such as stop signs are universal. Therefore, drivers might not experience much difficulty in knowing what to do when encountering one. Speed limits are the most common traffic laws, and are in place to let drivers know how fast or how slow they should be driving. Other traffic laws and regulations, however, are mostly specific to a particular section of roadway during a particular time. For example, left turns might not be permitted at an intersection during specific hours of the day. For such laws and regulations, a proper understanding of the actions or inactions required by traffic laws for particular locations during particular times is highly important to avoid violating them.

Moreover, violating a traffic law can have significant consequences, such as fines, increased vehicle insurance premiums, revocation of a driver's license, contributing to or causing a traffic accident, and even jail time. Traffic laws tend to be enforced by police officers or monitoring apparatuses such as red-light cameras, school zone speed cameras, etc. A motorist found to have violated a traffic law may be issued a citation (e.g., a ticket). A ticket ordinarily requires payment of a fixed amount of money, sometimes determined based on the facts of the particular case.

Tickets issued for traffic violations can be difficult to contest successfully, and often carry significant monetary penalties. Additionally, traffic violations impede the normal flow of traffic and can endanger public safety. Accordingly, increasing adherence of drivers to traffic rules is in the public interest. However, traffic rules can be complex, particularly in large cities such as New York City (NYC). For example, the New York City Traffic Rules and Regulations, Chapter 4 of Title 34 of the Rules of the City of New York, includes rules on traffic signals, pedestrians, bicyclists, motorists, drivers, restrictions on turns, speed restrictions, other restrictions on movement, rules for trucks, taxis and for-hire vehicles, truck routes, rules pertaining to parkways and traffic location limitations related to dimensions and weight of vehicles, and other information. Given such complexity, drivers commonly commit traffic violations unintentionally. Additionally, the constant congestion and increased use of vehicles on the roadways of cities can increase the frequency of traffic violations.

Although many traffic rules are transparent and understandable on their face, they are sometimes unclear in real driving situations because the manner in which the rules apply are not readily apparent. As a result, drivers often receive traffic violation tickets due to a lack of understanding or confusion about traffic rules and/or signs at specific locations. Furthermore, some traffic laws specify prohibited actions generally without addressing every detail of the prohibited actions in a practical manner (e.g., using examples of real traffic situations). Currently, there is no effective mobile-based application or web-based computer readable program, method, and/or system for navigation in vehicles which substantially reduces the rate of traffic violations.

In the view of foregoing, there is a need for a method and system for storing and updating traffic violation citation data for a plurality of locations, and helping drivers comply with traffic laws and rules at such locations to avoid traffic violations, citations, accidents, etc. Further, information resources are needed for users to educate themselves about traffic rules, regulations, laws, citations, etc. (hereinafter, “RRLC”) and the manner in which they apply in real traffic situations for specific locations to avoid traffic violations. The above-mentioned shortcomings, disadvantages and problems are addressed herein, as detailed below.

### SUMMARY OF THE INVENTION

This summary is not intended to identify or point to essential features or limit the scope of the subject matter claimed herein. The inventive disclosure relates generally to methods and systems for providing traffic violation avoidance guidance by categorizing various forms of traffic data based on data type or user type, identifying a location of a user, and notifying the user of potential violations based on the user's identified location and user type. Generally, the methods and systems for traffic violation avoidance guidance have at least the following objectives:

To help users avoid traffic violations and citations by alerting the user of potential traffic violations at or near a current location or any location requested by the user.

To inform a user of differences in traffic rules and regulations between different geographic regions, and the manner in which such differences apply to the user.

To provide a notification of a potential traffic violation based not only on an identified location of a user, but also on particular traffic data which applies to the user depending on whether the user is travelling with a commercial vehicle, a non-commercial vehicle, a particular type of vehicle, a vehicle with a particular type of plate, or a bicycle, or whether the user is a pedestrian.

To crowdsource new traffic data from any of a plurality of users through remote computing devices, to authenticate the new traffic data through ratings from additional users, and to modify or update stored traffic data based on the ratings.

To infer a potential traffic violation for a user based on traffic data and a particular user type.

To provide a reason for a potential traffic violation and/or a recommendation for avoiding the potential traffic violation applicable to a user based on the user's type during the user's approach to an intended location.

To provide information resources for users in relation to traffic RRLCs by using historical and real-time crowdsourced information available on traffic tickets.

To supplement deficiencies in publicly available government traffic data (such as incompleteness due to a lack of data and/or other relevant information due to privacy protection measures and other reasons) with up-to-date traffic violation related information and inform users in a timely manner.

In accordance with one aspect of the inventive disclosure, a method for providing traffic violation avoidance guidance includes categorizing the traffic data into at least one data type associated with at least one user, the at least one data type comprising at least one of: commercial vehicle, non-commercial vehicle, type of vehicle, type of vehicle plate, motorcycle, bicycle, or pedestrian, and providing at least one notification of a potential traffic violation based on (i) a location of a user; and (ii) the traffic data corresponding to the data type associated with the user.

In accordance with another aspect of the inventive disclosure, a method for providing traffic violation avoidance guidance includes categorizing the traffic data into at least one user type comprising at least one of: commercial vehicle user, non-commercial vehicle user, vehicle type user, vehicle plate user, motorcyclist, cyclist, or pedestrian, and providing at least one notification of a potential traffic violation based on (i) a location of a user; and (ii) the traffic data for the user type of the user. Additionally, the method may include providing a summary of differences between a first plurality of traffic rules associated with a first location and a second plurality of traffic rules associated with a second location, where the summary is based on at least one of the at least one user type.

In accordance with yet another aspect of the inventive disclosure, a method for providing traffic violation avoidance guidance includes providing a computing system configured for communication with a user and a plurality of additional users through at least one user engagement panel associated with at least one remote computing device, categorizing traffic data based on one of a user type and a data type, identifying a location of the user using a location determining apparatus in communication with the at least one remote computing device, analyzing the traffic data to predict at least one potential traffic violation based on at least a location of the user and a user type of the user, and generating at least one notification for the location based on the data type corresponding to the user type

These and other aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not limitation. Many changes and modifications may be made within the scope of the embodiments described herein without departing from the spirit and scope of the invention, and the embodiments herein include all such modifications.

### BRIEF DESCRIPTION OF THE DRAWINGS

A more complete appreciation of the inventive disclosure and many of the attendant aspects thereof will be readily obtained as the same becomes better understood by reference to the following detailed description when considered in connection with the accompanying drawings, wherein:

FIG. 1 is a schematic diagram illustrating a system for identifying potential traffic violations in accordance with an exemplary embodiment of the inventive disclosure;

FIG. 2 is a schematic diagram illustrating the structure of a computing device for reporting traffic violations and receiving a notification with traffic violation related data, among other things, in accordance with an exemplary embodiment of the inventive disclosure;

FIG. 3 is a schematic diagram illustrating a system and method for generating and transmitting a notification in accordance with an exemplary embodiment of the inventive disclosure;

FIGS. 4A-4B are schematic diagrams illustrating database content and organization in accordance with exemplary embodiments of the inventive disclosure;

FIG. 5 depicts an example of a mobile platform or remote computing device according to an exemplary embodiment of the inventive disclosure;

FIG. 6 depicts an in-dash vehicle display according to an exemplary embodiment of the inventive disclosure;

FIG. 7 depicts an in-dash GPS display according to an exemplary embodiment of the inventive disclosure;

FIG. 8 depicts a user engagement panel display according to an exemplary embodiment of the inventive disclosure to correct, update, and supplement traffic violation related data within the database;

FIGS. 9-14 depict aspects of methods according to an exemplary embodiment of the inventive disclosure;

FIG. 15 depicts a flowchart illustrating data verification according to an exemplary embodiment of the inventive disclosure; and

FIG. 16 depicts a flowchart illustrating a method of informing a user of potential pitfalls in locations near and around a geographical area between a user's current location and an intended destination according to an exemplary embodiment of the inventive disclosure.

### DETAILED DESCRIPTION

In the following detailed description, reference is made to the accompanying drawings that form a part hereof and in which specific embodiments that may be practiced are shown by way of illustration. The described embodiments may enable those skilled in the art to practice the embodiments, and it is to be understood that logical, mechanical and other changes may be made without departing from the scope of the embodiments. The following detailed description is therefore not to be taken in a limiting sense.

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner. Although the invention may be described herein with reference to a modern metropolis such as NYC as the main example for implementation, the systems and methods disclosed herein are applicable worldwide.

The systems and methods disclosed herein integrate an electrical/digital map (e.g., Google Maps™, which is an electronic mapping service provided by Google, Inc., etc.) of a mobile application on smartphone/web-based/storage media. With this integration, the roadways are displayed from the map database, which presents the analyzed data for specific locations and explanations of ticket violations in a manner that is easily understood by the user. It will be appreciated that other mapping systems and methods may also be employed within the spirit and scope of and in accordance with the inventive disclosure. The system connects internally with various functions of a mobile device, including a clock function, phone call function, microphone, GPS tracking for geo-location mapping (latitude and longitude coordinates), and/or camera, etc. The mobile application runs on the mobile device and utilizes resources which include a microprocessor, memory, GPS, wireless connection and a display. The notifications may be presented through one or more media such as a visual display, an audio system, a voice or audio notification, etc.

As used herein, the term “user(s)” is intended to encompass not only driver(s), but also individuals who may not be a driver or driving, such as pedestrians, bicyclists, motorists, passengers, and/or users of autonomous vehicles. The inventive disclosure may assist such users in avoiding traffic tickets. The terms “traffic citation(s)”, “traffic ticket(s)”, or “traffic violation citation(s)” are used interchangeably herein, and refer to a ticket and/or summons a user receives for a traffic violation.

Exemplary embodiments of the inventive disclosure may include users who are members of the general public and/or computer systems, including but not limited to professionals, drivers, bicyclists, motorcyclists, vehicles, websites, robots, in-vehicle systems, Global Positioning Satellites, and/or other systems. It is also intended that exemplary embodiments of the inventive disclosure are used not only within a mobile device application of a mobile device, which may include smartphones, tablets, laptop computers, in-dash vehicle systems, etc., but also other systems or services which may process, utilize, and display traffic violation-related data. For example, exemplary embodiments of the inventive disclosure may contribute to the field of information services for online mapping companies and GPS manufacturers, smart phone/mobile device manufacturers, wireless service providers, mobile application creators and developers, mobile operating system developers and distributors, automated or autonomous vehicle systems that do not require a physical driver in the vehicle, etc.

A potential user of the system or services thereof may be asked to register by providing pertinent driver, motorcyclist, or bicyclist license information, including name, email address, plate information such as type of plate or type of vehicle, the state/country issuing the user's license(s), etc., to create a user ID for each user of the application. The user IDs can be used for tracking reports and in connection with ratings relating to various forms of crowdsourced or other traffic data, reasons, or recommendations (further discussed below). Credit card and/or debit card information may also be requested, as well as subscriber fees for certain services the application (e.g., the mobile application) provides for a certified or registered user. As further discussed below, subscriber fees collected directly or indirectly may be used, in whole or in part, to fund a source which helps pay for a user's incurred tickets as a part of a reward system, and which may incentivize obtaining more ticket information.

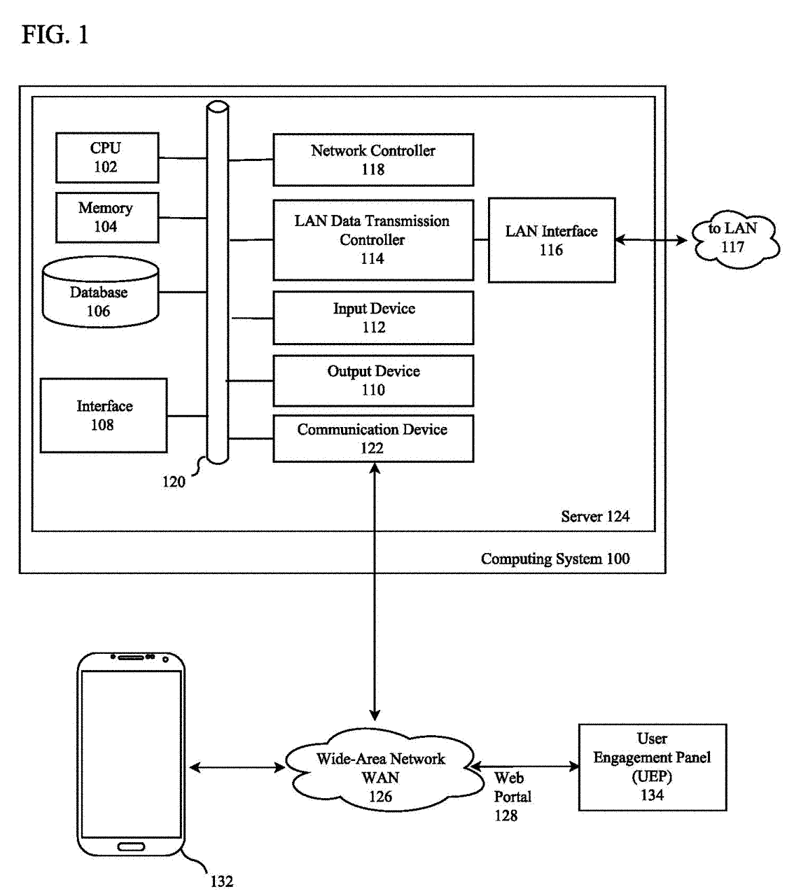

Turning now to FIG. 1, depicted is a schematic diagram illustrating a system for identifying potential traffic violations in accordance with an exemplary embodiment of the inventive disclosure. System components in communication with computing system 100 may include computing device 132, wireless wide-area network 126 (WAN) 126, web portal 128, and user engagement panel 134. User engagement panel 134 may be provided through remote computing device 132 or through any other external computing device. A combination of hardware and software operates on an application of computing device 132 and a computing system 100, such as a computer, generally with one or more connections to WAN 126 (e.g., the Internet).

Computing system 100 may include, for example, server 124 comprising one or more of the following: central processing unit (CPU) 102, memory unit 104, database 106, interface 108, output device 110, input device 112, (e.g., a keyboard, mouse, scanner, etc.), local area network (LAN) data transmission controller 114, LAN interface 116 (for connection to one or more LANs 117), network controller 118, which can be connected to a PSTN (public switched telephone network), and internal bus 120. As shown, the system may be connected to a data storage device such as a hard disk comprising database 106 via a link. Computing system 100 can include one or more servers configured the same or similar to server 124, or one or more servers configured in a different manner, which may include different hardware or software. For example, computing system 100 may comprise multiple servers hosted in multiple spaces such as data centers or server farms.

Computing system 100 may be configured to communicate with a network service coordinated through communication device 122, which may include any approach for communicating data over one or more networks or to one or more peripheral devices, and may include circuitry and control systems for providing wireless connections, wired connections, cellular connections, data port connections, Bluetooth® connections, or any combination thereof, and the device or means may include devices enabled to communicate using such communications approaches. Server 124 and computing system 100 may also be communicatively linked, through communication device 122 and WAN 126, to peripheral devices such as computing device 132. One of ordinary skill in the art will appreciate that there are numerous approaches for communications that may be utilized.

Computing device 132 may be a device which allows a user to interact with computing system 100. Through computing device 132 and web portal 128, the user can access a remotely or locally provided user engagement panel 134. Computing device 132 may be a handheld mobile device, an in-vehicle navigation system, or another device or system such as a laptop computer, desktop computer, tablet, etc. User engagement panel 134, according to one embodiment of the inventive disclosure, may be a discussion board that can be accessed through an interactive display on computing device 132, which allows users to interface with or engage in communications relating to traffic and traffic violations, and which may include recommendations for complying with traffic rules and regulations, avoiding traffic violations, suggestions for disputing tickets, and ways for users to assist one another with payment of and/or disputing fines, penalties, etc. User engagement panel 134 may be configured such that a user may input data based on user type and/or data type. A user having a particular user type may be allowed to input data which does not correspond to the data type of the data being inputted (e.g., a user having a pedestrian user type may input data having a commercial vehicle data type, etc.).

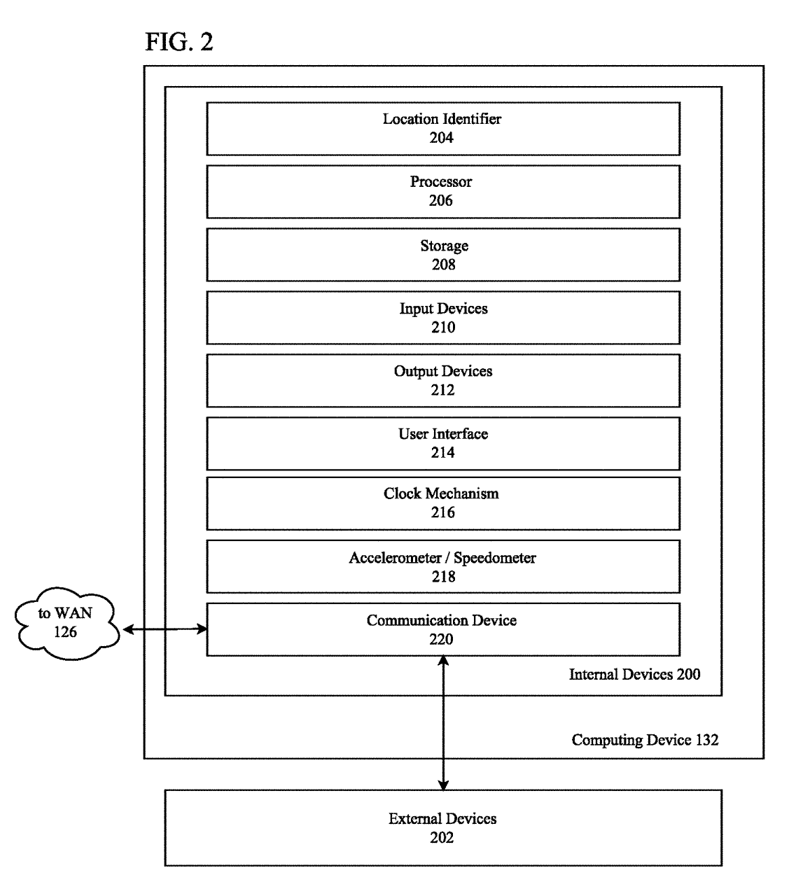

Turning to FIG. 2, shown is a schematic diagram illustrating the configuration of computing device 132 for enabling a user to interface with computing system 100 and for reporting traffic violations and/or other information relating to traffic or potential traffic violations, and for receiving a notification with traffic violation related data. Remote computing device 132 may be in communication with all of its components, tangible or intangible, and may incorporate internal devices 200 and external devices 202. Remote computing device 132 may also include and utilize mobile communication device 220 for receiving voice, text, and data for connecting to computing system 100 such as over WAN 126. Location identifier 204, such as a GPS receiver, may also be included in remote computing device 132 for identification of a present location. Location identifier 204 may determine the location of remote computing device 132 in different ways, for example, through receiving location-based resources. One of ordinary skill in the art will appreciate that there are numerous approaches for providing location identification and location-based services. In one example, location identifier 204 can process received GPS data from location-based or geo-aware resources of computing device 132. In addition, location identifier 204 can also receive GPS data from other applications or programs that operate on or in conjunction with computing device 132. For example, computing device 132 may communicate with one or more other applications using one or more application program interfaces (APIs). The application can use the location information to cause a user interface component to configure a user interface framework based on the location information.

Computing device 132 may also include one or more processors 206, storage 208, input devices 210, output devices 212, user interface 214, clock mechanism 216 and/or accelerator/speedometer 218. Processor 206 may be used for executing instructions, software, or program modules on computing device 132. Remote computing device 132 may also contain storage 208, such as random-access memory (RAM) or flash storage. Input/output (“I/O”) devices 210/212 may be used to connect computing device 132 to other system implements, especially depending on the available functionalities of computing device 132. For example, an in-vehicle navigation system might not have a camera, while a mobile device may have a built-in camera. In this instance, a mobile device's camera may be used as an input for the in-vehicle navigation system. Other I/O devices 210/212 may include a scanner, a microphone, a speaker, etc. Remote computing device 132 may also include an output device such as display 212, which may display a notification or other data to a user received from computing system 100. Display 212 may be, for example, an electronic touchscreen display such as an LCD display, an LED display, or an active-matrix organic light emitting diode (AMOLED) display. Computing device 132 may also utilize internal clock mechanism 216 to determine the time at any given moment during its use. Accelerometer or speedometer 218 may also be in communication with computing device 132, which may be used to measure speed, acceleration, directional changes, etc. An exemplary embodiment of the present disclosure may also implement user interface 214, where content is displayed based on other user selections and preferences.

One or more of these components of remote computing device 132 might be combined to provide user features that are specific to user selections and user locations, and/or real-time conditions to enable a user to receive traffic violation related information. These selections can be displayed to the user, and the user can use user interface 214 to interact with information. For instance, user interface 214 can correspond to a program that is downloaded onto a smartphone or other portable computer device such as a tablet computer or personal digital assistant (PDA). A user can download and install the application on remote computing device 132 and register. An exemplary embodiment of the inventive disclosure may utilize pre-programmed features combined based on certain protocols or methods of integration of basic components, such as servers, databases 106, mobile end applications, web portals, network settings, etc. The applications can be applications written for ANDROID, a mobile platform developed by Google and the Open Handset Alliance, IOS, a mobile platform developed by Apple, Inc., WINDOWS PHONE, a mobile platform developed by Microsoft Corporation, etc.

A possible user interface 214 may include, but is not limited to, a homepage user interface, access to user engagement panel 134, which may be used for one or more users to provide crowdsourced traffic data or to share ideas about avoiding traffic violations, a summary interface, a location user interface, database 106 access interface, or a combination of any of the features described. One of ordinary skill in the art will appreciate that there are numerous user interfaces that could be utilized or contemplated for use with any appropriate user interface 214. External devices 202 may also be connected to remote computing device 132 through either a wired or wireless connection, and may be one or more devices that could provide additional or enhanced functionalities to computing device 132, whether it be a mobile device such as a tablet or smartphone or an in-vehicle navigation system or other computing device, etc. Computing system 100 can retrieve a user's information and other data that is stored in database 106. In some implementations, database 106 can be remote and user information can be retrieved from there.

Other integrated devices may utilize vehicle equipment, such as cameras, inertial sensors, gyroscope sensors, GPS sensors, and any other applicable equipment. Utilization of such vehicle equipment may be used to obtain comprehensive real-time and historical information about the vehicle, such as its direction, speed, orientation, acceleration, etc., in order to enable system 100 to issue an applicable and accurate notification to the user. An exemplary embodiment of the inventive disclosure can, for instance, be integrated with in-dash systems to enable full function within a vehicle. This integration is not limited to in-dash systems, and may also be integrated in the vehicle by original equipment manufacture or third-party add-on equipment that may be mounted within a vehicle. In such embodiments, the disclosed architecture can be integrated directly into a vehicle's computer system.

When integrated into an in-dash navigation system, the vehicle's display may be used to show a traffic violation related notification in accordance with exemplary embodiments of the inventive disclosure. The in-dash integrated system can provide remote updates and communications to the user through an installed traffic violations application on a user's computing device 132 to notify the user, for example, when a traffic rule, regulation, or issue such as a road or lane closure is occurring, has occurred in the past, or is about to occur. Other traffic or traffic violation related data may be displayed. The installed traffic violation avoidance application can run on computing device 132 and utilize resources which may include a microprocessor, memory, GPS, wireless connection, and display.

The inventive disclosure may be used with automated vehicle systems such as self-driving cars where data can be integrated into the vehicle's navigation system, and notifications can be sent directly to the vehicle. Though self-driving vehicles do not require drivers, the vehicles themselves are still subject to traffic violations that may be issued to their owners. Traffic violation notifications integrated with an autonomous vehicle's navigation system may help the owner of an autonomous vehicle avoid traffic violations and citations resulting from the vehicle's operation. Thus, it will be appreciated that system 100 may potentially be employed by self-driving/autonomous vehicle technology, with further developments effected through integration with crash-avoidance systems. While many aspects of autonomous vehicles remain under development, it will be appreciated that the systems and methods disclosed herein offer improvements thereto by providing a computer-implemented system and method, which may be used therewith for avoiding potential traffic violations.

For example, system 100 may be integrated into existing hardware, such as external sensors and processors, and software which may be associated with an autonomous vehicle. It will be appreciated that with respect to self-driving cars, data can be integrated into the vehicle's navigation system, with notifications sent directly to the vehicle. Self-driving vehicles may also include autonomous car sensors, which measure the distance from the car to obstacles, and with cameras that detect traffic objects like lights and road signs, and help recognize moving objects like other vehicles, pedestrians, and bicyclists. Such technology can be used in conjunction with the system and methods disclosed herein to help users avoid traffic violations, avoid accidents in driverless vehicles, and potentially avoid liability. For example, users may be deemed at least partially responsible for violations committed by self-driving vehicles, depending on, for example, how the user configures the self-driving vehicle, what settings are utilized, and whether the user manually overrides computer systems utilized by the vehicle at particular locations.

Exemplary embodiments of the inventive disclosure may optionally include a geographical information system (GIS) to capture, display, and otherwise analyze data. The GIS may integrate an electronic/digital map to be viewed on computing device 132. With this integration, roadways may be displayed from a map database which presents the analyzed data as to the locations of potential traffic violations and route planning to offer alternative routes where such violations are less likely to occur. Options can be displayed to the user to help plan his/her route accordingly, or to see automatically generated suggestions about routes, etc. A user may be given the option to select an alternate route based on additional route criteria. The GIS may integrate different layers, and data points with similar attributes can then be isolated and outputted as a layer that can show instances of certain data points having similar attributes. An inventory of other data points such as commercial vehicle zones, taxi lanes, bus lanes, bicycle lanes, emergency lanes, no idling zones, etc., can be gathered and applied through a GIS, output to the user's computing device 132, and visualized on a base map. Such methodology provides a way to usefully sort, access, and send data to a user of computing device 132.

The GIS might include certain hardware, which might be another computing device or secondary device attached to it that enables the GIS to be functional, and software such as algorithms written using executable programming languages to store, analyze, and display geographical data and information. The GIS may be maintained by a technician, or other qualified personnel, with knowledge of upkeep procedures, especially those concerned with adjusting system functions to what might be required of a GIS.

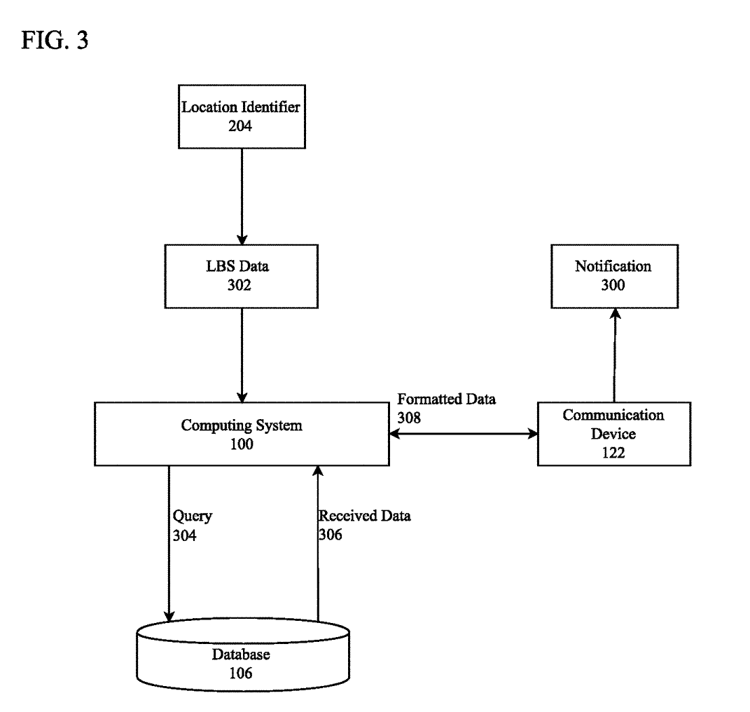

Turning now to FIG. 3 shown is a schematic diagram illustrating a system and method for generating and transmitting a notification relating to the identification of potential traffic violations, areas where particular traffic maneuvers are not allowed, and the like, in accordance with exemplary embodiments of the inventive disclosure. In operation, remote computing device 132 connects to computing system 100 to transmit a notification when relevant. A user may be provided with a visual and/or audio (e.g., voice) notification. Computing device 132 and/or location identifier 204 send location-based services (LBS) data 302 to computing system 100. When certain conditions are met (e.g., the user manually requests traffic, traffic rules, or traffic violation information), computing system 100 can query 304 data in database 106. The query might include a user type of the user (e.g., the user drives a Camry with commercial plates), which can be cross referenced with the location of the user gleaned via LBS data 302 (e.g., approximate address, geolocation, etc.) and the time (e.g., time of day, week, month, season, etc.) to identify relevant data for generating a notification tailored to the user's customizable preferences (e.g., how, when, and how often the user wants to be notified, a time the notification(s) is/are issued, a distance to an intended destination, an amount of time before a user reaches an intended destination, a form of the notification(s), a number of times the notification(s) is/are requested, a content of the notification(s), one or more locations where the notification(s) is/are issued, etc.). Computing system 100 may periodically query 304 certain data sets in database 106 to keep requests current or to look for new or different information in database 106. Alternatively, computing system 100 may access database 106 using specific APIs, by subscription, or by this data being pushed as it is made available. During the process, computing device 132 may connect with internal devices 200 and external devices 202 to communicate with computing system 100 to relay data (i.e., time, date, location etc.), receive a notification, and process and display that notification to the user.

Customizations may be, rather than based on user preferences, automated from collected data from the database. For example, system 100 may use a customization based on a predetermined number or percentage of users selecting a specific preference, or based on reasons or randomization. For example, if the system is using 75% as a predetermined percentage for users, if 90% of users choose to be alerted one time for a specific location, then the system may automatically customize a one-time alert for that location for all users in the absence of any particular user requesting otherwise. In another example, when a majority of users chose to receive recommendations at a specific location, the system may automate recommendations for all users at that location absent instructions or customized settings to the contrary from each particular user. Thus, customizations may be discretionary and selected by users, and/or may be automated by the system based on past user data.

The received data 306 from database 106 based on query 304 may be formatted at computing system 100. The formatted data 308 can then be transmitted as notification 300 through communication device 122, which can appear on remote computing device 132. To generate notification 300, computing system 100 may query 304 different data sets within database 106 (e.g., any historical citation information currently available, the user's identified location and present time, and/or any administrative notices or temporary notices applicable to the user type of the user, present location, and present time, etc.). Furthermore, computing system 100 can search for weather related information, where weather patterns or conditions could have an effect on traffic rules and regulations or potential violations thereof.

Notification 300 can be configured to be integrated with an interactive electronic map API or displayed on an electronic screen. Notification 300 that is specific for a commercial vehicle, for instance, might include specifically relevant information for commercial vehicle users in it. The information contained within notification 300 can be based on specific data from the combination of data for commercial vehicles, as notification 300 may be selectively issued based on the user's user type, further based on type of vehicle and type of vehicle plate, etc. A notification may be short, conveying traffic related data applicable to a location.

Computing system 100 may alert the user to potential traffic violations or changes by notifying the user through email, text message, phone call, phone alert, voice mail etc., automatically at the choice of the user, who may set such form of notification in advance in system settings. Notification 300 to the user can include reasons for the potential traffic violations and/or changes, such a lane closure that does not have proper signage and/or sufficient advance notification. While referenced as “reasons,” one of ordinary skill in the art will appreciate that in practice the meaning of this phrase can be conveyed in numerous ways, including, but not limited by phrases such as “cause,” “explanation,” or any other terms. The terms used herein to describe this concept are meant to mean that the user is given an explanation as to why traffic RRLCs are possible, happening, changing, or unclear at a given location.

Additionally, notifications may also provide recommendations to the user for avoiding the potential traffic violations. For example, if a user is near a location where certain traffic related restrictions or authorizations are about to expire, notification 300 may notify the user of this impending change. While referenced as “recommendation,” one of ordinary skill in the art will appreciate that “suggestion,” “advice,” or any other terms may be used herein to describe this concept.

System 100 may display a comparison of traffic rules applicable at different jurisdictions. The comparison may be displayed in different ways, such as notification 300 through user engagement panel 134, or by any other format. The comparison may be made based on information obtained from user data provided from the user, such as a driver license, driving history, preferences, etc. System 100 may use not only the driver license itself, but also information associated with the driver license, such as the city, town, state, and authorities that issue the traffic rules for the driver license jurisdiction, and the traffic rules which apply in that jurisdiction. For example, the system may compare rules that apply at the current location with the rules of the state that issued the user's driver license. A comparison of the relevant rules is necessary to notify users of the differences between the rules of their current locations and those from where the user's driver license was issued. This allows the user to find potential traffic violation areas in other jurisdictions, and/or to plan a route to a specific location or region having less traffic restrictions. This is important because traffic rules may differ in different jurisdictions, and it is important to identify which rules apply in which jurisdiction. The stored traffic related data from those locations may be summarized, compared, and analyzed to alert the user based on the different traffic rules between the user's original location and the current location determined by the user. The user may provide a specific location and view the traffic information at that specific location within a predetermined distance from the specific location, and may check traffic information pertaining to any location at any time. In another scenario, a user may select and compare traffic rules of multiple other locations, such as locations unrelated to the user's current location or to the jurisdiction associated with the user's driver license. The differences may then be displayed on the user's computing device 132.

As discussed above, system 100 can be configured to provide notifications and summaries of differences between traffic laws and rules of two different geographic locations (cities, countries, states, etc.). System 100 can also be configured to inform a user of how any such law or rule change would apply to the user and/or the user's vehicle. Two cities in a particular country may have different rules concerning, for example, turning right at a red light, driving on a particular avenue, or driving in a particular lane on certain avenues. Additionally, such rules may only apply during particular days or time periods and/or to particular types of vehicles (truck, commercial, noncommercial, etc.). In the summary provided to the user via user engagement panel 134, system 100 may include the rule change as well as how it applies to the particular user. If a user is in a foreign country, then particular rule variations might be more significant than rule variations between jurisdictions or states within a single country. While the traffic laws of the jurisdiction associated with a user's driver's license can be compared to the traffic laws and rules of the user's present identified location as discussed above, in alternative embodiments, system 100 may allow the user to input the two locations for which a comparison is desired. In this manner, the comparison/summary can be generated in advance of the user's trip, or prior to the user arriving at a particular destination. Such summary and explanation may help a user prepare for a domestic or overseas trip, or may simply inform a user of what types of traffic rule differences there would be between two input locations.

System 100 may be configured to provide this notification 300 automatically, or to allow the user to manually select when and where to receive notifications 300. For example, the user may be able to view notification 300 information by pressing a button on the screen of computing device 132 at the location to check for different traffic rules. Alternatively, system 100 may be set to automatically alert the user within a predetermined distance from a determined location. A user may rate information on notification 300 in part or in whole and also report notification 300 to the system administrator if the user believes there is inaccurate or false information.

As an exemplary embodiment of the inventive disclosure records and stores accurate geolocation GPS coordinates of the user's computing device 132, notification 300 sent to a user can be customized and localized to the user's location. Since system 100 and database 106 stores and analyzes RRLC data from different municipalities and/or other authorities, geolocation and applicable RRLC data may be matched to send notification 300 according to the user's user type and current location or a location indicated at a user's request. For example, location identifier 204 may transmit the location of computing device 132 to place the user within a particular set of jurisdictions. This function may be useful for a user who drives across local, county, state or country lines and is unfamiliar with the RRLC data from different cities, counties, states, countries, etc. Database 106 may store the user's driver license information, as the user may enter and store the information of the driver license with the state or country who issued the driver license when registering a profile. Using the location from where the user's driver license was issued with a user's current location data, computing system 100 may send a notification for different rules or a summary of different driving or traffic rules to the user according to the location as it changes. Optionally, the user may press a button on the display of computing device 132 to view the summary of the different traffic rules when comparing the location of the entity that issued the user's driver license with the user's current location.

System 100 may also be integrated with third-party weather APIs to retrieve historical weather information for general or specific zones to predict future traffic violation situations where weather may have an impact on traffic conditions, situations, rules, or regulations. For example, if computing system 100 detects through a weather API an identified location where the user is travelling subject to any expected snowfall or flooding, it may compare this information to the historical traffic related data within database 106 to find out if there may be any weather-related traffic restrictions and/or an increased number of traffic violations in the zone which may be applicable. The user may receive a notification when the weather forecast is similar to situations from historical data that reflect an increase in the number of violations for a certain area due to the same weather conditions.

A user may customize notifications 300 in accordance with his/her preferences. Thus, in addition to having a notification 300 issue on the basis of the data type corresponding to at least the user type that the user belongs to, the user can optionally specify further what he/she does or does not want to be notified about, which may result in precluding a single notification or a whole category of notifications. The notification preferences may include, but are not limited to, time(s), location(s), distance to an intended destination, time before an intended destination, form or format of the notification(s), content of the notification(s), number of times the notification(s) is/are requested, a time the notification(s) is/are issued, an amount of time before a user reaches an intended destination, and a location where the notification(s) is/are issued, etc. As to time(s), a user may want notifications on nights and weekends while being turned off during business hours, or can make other customizations to limit notifications to certain times. As to location(s), a user who often travels in the same area each day could specify that notification 300 relevant to that location or route might not need to be displayed, as the user may be familiar with the traffic rules. As to distance to an intended destination, a user may predetermine a distance to an intended destination at which he/she would like to start receiving notifications. As to time before reaching an intended destination, a user may predetermine an amount of time before reaching an intended destination that he/she would like to start receiving traffic notifications. As to format, a user may wish to receive notifications in the form of text, image, audio, video, etc. or a combination thereof. As to content, a user can specify the type of information he/she would like to see in notification 300. For example, a user may specify that he/she does not wish to see any image of a sign or signage, instead opting to simply view a short description of the sign or signage. As to number of times, a user may also set the number of notifications the user would like to receive. For example, a user may want to receive an inquiry or notification once or twice, or the user may not want to receive any notification, etc. If the user does not respond to notification 300, computing system 100 may stop sending notification 300 after it repeats for a predetermined number of instances set by the user. System 100 may be configured to allow entire categories of notifications 300 or specific parts thereof to be turned off. For example, a user might not feel the need to see notification 300 that serves as a reminder or any other traffic related data for which the user already feels well informed. However, these are mere examples and not intended to limit in any way the potential customizations that the user can specify regarding which notification 300 is issued, and is not intended to limit the information incorporated into database 106.

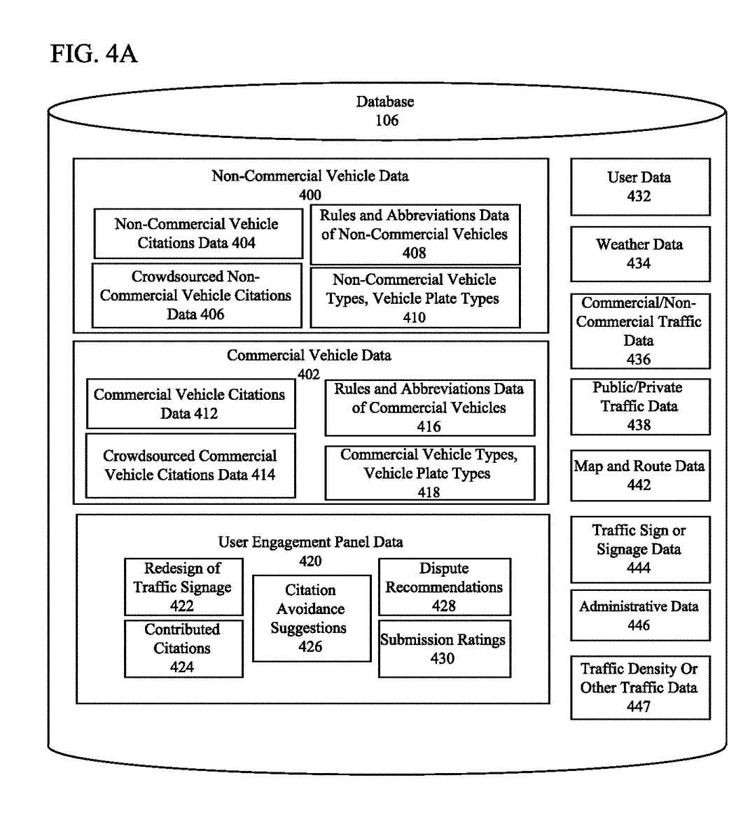

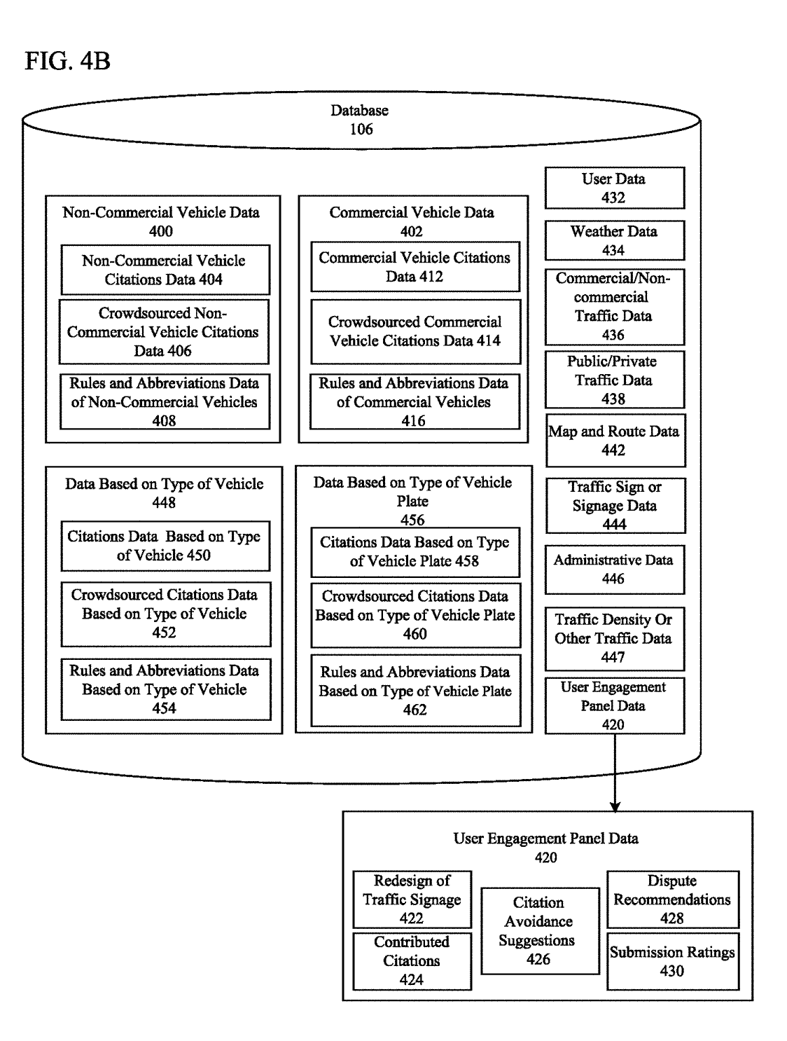

Turning now to FIG. 4A, shown is a schematic diagram illustrating the content and organization of database 106 in accordance with an exemplary embodiment of the inventive disclosure. System 100 may use database 106 or a set of databases (or data storage media) disposed on a hard disk, one or more hard disks, or other storage means. Information in database 106 may be stored in a non-relational or unstructured manner. One of ordinary skill in the art will appreciate that there are numerous methods for providing, storing, and organizing data in database 106 or other data storage media. Additionally, there may be at least one backup database that may back up a primary database periodically in case of data loss in the primary database. While referenced as a database, one of ordinary skill in the art will appreciate that in practice this could be implemented in numerous way, including but not limited to a data storage medium, whether structured or unstructured, relational, or otherwise. One of ordinary skill in the art will also appreciate that there are numerous methods of providing databases and data storage media for the organization and retrieval of specific information, contemplated for use with any appropriate database 106 or other storage means. Further, as stated, the exemplary embodiments disclosed herein are contemplated for use with one type of data processed and stored corresponding to one type of user, though certain embodiments of the inventive disclosure may incorporate multiple types of data corresponding to multiple types of users, or one type of data corresponding to multiple types of users, or multiple types of data corresponding to one type of user.

Traffic related data may include, for example, traffic rules, vehicle traffic rules, motorcycle traffic rules, cycle traffic rules, pedestrian traffic rules, temporary traffic notices, violation codes, traffic violation citations, and traffic sign content for commercial vehicles, non-commercial vehicles, motorcyclists, cyclists, and pedestrians, and can be categorized in database 106 according to different data types or data sets. For example, drivers of non-commercial vehicles may receive tickets for driving, idling, turning, or otherwise maneuvering in commercial vehicle only zones which only permit commercial vehicles. Therefore, database 106 may store a record of traffic citations including citation data from non-commercial vehicles (historical citations and real-time citations) 404, 406 and citation data from commercial vehicles (historical citations and real-time citations) 412, 414, which may be labeled and sorted accordingly. Traffic related data based on vehicle type may show different types of vehicles which commit traffic violations. Based on this organization, different types of users may then be issued a notification with the type of data that correspond to at least their user types. In this manner, notifications can be issued which are more accurate and/or applicable, as various citations can be grouped in separate categories depending on the type of vehicle and types of vehicle plates with which they are associated (e.g., commercial vehicles, non-commercial vehicles, types of vehicles, or types of vehicle plates).

User type is intended to cover every type of vehicle that may be subject to or restricted by traffic regulations under various traffic regimes. User types may be categorized into any one or more of the following: commercial vehicle user, non-commercial vehicle user, user types based on type of vehicle, user type based on type of vehicle plate, or any other user type such as pedestrian or bicyclist. Thus, it will be appreciated that a user's “user type” can correspond to the type of vehicle the user is driving or riding in as a passenger, the type of license plate on the vehicle, the type of motorcycle or bicycle the user is riding, or the fact that the user is travelling on foot. For example, trucks and taxis may be classified differently under the law and each may have its own distinct vehicle plate with traffic rules affecting each type of vehicle differently. Therefore, a specific user type may be selected to access traffic data that corresponds only to that user type while precluding traffic data for all other user types. Optionally, a user may select more than one user type to access traffic data related only to the selected user types. In this manner, a user can receive notifications or updates based on data corresponding to each user type that has been selected, or for just one user type. System 100 may store one or more user types for each user depending on the user's licenses, vehicles, and other information the user inputs to system 100.

Database 106 may contain several data types, categories or groupings that establish data sets, including but not limited to, non-commercial vehicle data 400, commercial vehicle data 402, user engagement panel data 420, user data 432, weather data 434, commercial/non-commercial traffic data 436, public/private traffic data 438, map and route data 442, traffic sign or signage data 444, administrative data 446, and traffic density or other traffic data 447. Non-commercial vehicle data 400 may further include non-commercial vehicle historical citations 404 and non-commercial vehicle real-time citations 406, where the real-time and historical sections of database 106 can be independent or synchronized to retrieve information from both sections at the same time. All historical traffic related data in database 106 may also be corrected, updated, supplemented or otherwise modified by real-time traffic related data or traffic related data that had as of yet been unknown or unavailable.

One of ordinary skill in the art will appreciate that database 106 may not necessarily include all data types. Instead, it may be configured to include the data of only one data type, a combination of several data types, or even additional data types. For example, if system 100 is configured to be utilized only by users of certain types of vehicles (e.g., such as autonomous vehicles), then database 106 would only include data based on type of vehicle 448 pertaining to automated vehicles. Similarly, a user type may be a passenger or “driver” of an autonomous vehicle.

Real-time traffic related data is considered to be real-time when one or more users share traffic related data immediately. “Immediately” can be within a predetermined period of time close to a present time, such as fifteen minutes from receiving the traffic violation, or it may be virtually instantaneous with the present time. If the data does not meet requirements to be considered real-time data (e.g., within five minutes, half an hour, or even several hours of an incident, observation, or receipt of a citation), then the data may be considered historical, but may still be used to update other historical traffic related data already in database 106. In accordance with certain embodiments, data in database 106 can be classified as real-time data and/or historical data. Historical data can be collected not only from crowdsourcing, but also from publicly available information. If, for example, a user receives a ticket/citation and immediately uploads information associated therewith, or does so within a predetermined time period, then the data may be considered real-time. Conversely, if the user instead uploads the information a day or two after receiving the ticket, then the information may be considered historical information or historical data.

Non-commercial vehicle data 400 may further include rules and abbreviations data (and their common meanings) relating to non-commercial vehicles 408 as used by law enforcement. On a ticket, abbreviations may appear in the area where the officer specifies the violation and/or location of the violation. Abbreviations may be processed and stored in database 106 by gathering data from publicly available sources to provide the most accurate and up-to-date meanings. The user may be able to check the language to automatically change the abbreviations to plain-language meanings according to location when typing them into computing device 132. The function may also be used when the user reports a ticket that contains abbreviations. For example, a user may receive a ticket for driving a vehicle in violation of the law at a certain location and intends to report it. The ticket violation may state, the “Place of Occurrence” is “E/S Main St. 0ft N/of Second Ave.” The user may, for example, type the abbreviated language into computing device 132 when reporting, and then computing system 100 may automatically change the abbreviations to plain and easily understandable explanations and then convert the address into a geolocation. For example, tickets with confusing abbreviations, “E/S Main St. 0m N/of Second Ave.” would be changed to “East side of Main Street zero meters North of Second Avenue”, and used to create the accurate geolocation through a third party's geolocation API to be entered into database 106. This geolocation may then be precluded for purposes of identifying potentially available traffic-violation free zones for a relevant user at a relevant time, because a user has received a ticked for driving illegally.

Non-commercial vehicles data 400 may also include data relating to non-commercial vehicle types and non-commercial vehicle plate types 410, which can be stored in database 106 as such. This may include types of vehicles that fit the non-commercial vehicle type or have non-commercial vehicle plates for users, so that the users can be grouped properly by data type.

Database 106 can also store commercial vehicle data 402. This data set may include: commercial vehicle historical citations 412, including past citations issued to commercial vehicles; commercial vehicle real-time citations 414, including real-time citations just issued to commercial vehicles; rules and abbreviations data of commercial vehicles 416, including abbreviations and rules that apply to commercial vehicle traffic citations; and commercial vehicle types and commercial vehicle plate types 418, which include types of vehicles and types of plates associated with commercial vehicles. With respect to the type of vehicle or type of vehicle plate, the data type might correspond to at least the type of vehicle or type of vehicle plate. For example, trucks and taxis may each bear a different type of vehicle plate specialized for their respective industry, although they may both be classified as commercial vehicles, and each of these user types can receive data corresponding to at least a user type while precluding data for all other vehicle types. In other words, data corresponding to a particular user type, may be focused to that user type, whether based on type of vehicle or vehicle plate, or other specification, especially in a scenario where a traffic/driving prohibition or availability is based on the vehicle (e.g., commercial vehicle driving/idling/loading only).

Database 106 may also include user engagement panel data 420, which may include any information or data submitted by one or more users using the user engagement panel 134. This user engagement panel data 420 may include one or more of the following: submitted redesigns of traffic sign or signage 422 (e.g., to make the traffic sign or signage clearer), citations contributed by users 424, which might include discussion and/or comments related to that contribution, traffic citation avoidance suggestions 426 that can be collected from users, which can include suggestions for a specific location or generally, dispute recommendations 428 from users who might give advice to others on effectively disputing traffic tickets, and submission ratings 430 for user engagement panel data 420. Ratings can be used as a way to sort or weight information within user engagement panel 134 so that users might be able to see the most accurate or helpful information, and so users who contribute meaningfully for doing so can be rewarded for their contributions.

Database 106 can also include user data 432 (i.e., information about the users), which can include where the user travels or has traveled, and possible user registration information, such as the user type selected by the user, etc. A user may be asked to register with the service by providing driver license pertinent information such as name, type of vehicle plate, type of vehicle, the state or country issuing the driver license, and an email address to create a user ID for each user of the application. User IDs may be used for the purposes of tracking reports and ratings made by each user. Credit card and/or debit card information may also be requested for subscriber fees for certain services provided for a certified user. A registered user may be allowed to use various features of the application, including, for example, reporting data and rating data. The subscriber fees collected may also directly or indirectly fund monetary or non-monetary rewards implemented as an incentive for providing traffic related data, including but not limited to received traffic tickets. System 100 may include a user profile in database 106, and is configured to store user information and associations between each user and the user's remote computing device 132 after registering. Once registered, a user may set and change the information in their respective user profiles, if desired. Settings that require a user's input or preference may be subsequently changed by the user within the settings (e.g., on/off). For example, a user may change the type of vehicle the user is currently driving. Accordingly, this is also applicable to the type of plate associated with the vehicle, and can be included and stored with user data 432. Weather data 434 may also be stored in database 106, and can relate to past weather patterns and how they affect traffic and the legality of particular driving rules, regulations, laws, or maneuvers. For example, in certain bad weather situations, traffic rules might be affected. Database 106 can also store data relating to commercial/non-commercial traffic data 436, and public/private traffic data 438. Such traffic data 436, 438 may be listed with information from third parties, whether government or public, commercial or private.

It will be appreciated that commercial vehicle data 402 may include rules, regulations, laws, and information on various types of trucks, size and weight requirements thereof, etc. Such requirements may be particular to specific locations, such as bridges, highways, tunnels, narrow passes, etc. Non-commercial vehicle data 400 may include information such as bike lanes, bus-only lanes, etc. Both commercial and non-commercial vehicle data 400, 402 may include, for example, speed limits in specific locations such as school zones, and the applicable times associated with these traffic rules, regulations, and laws. Map and route data 442 can be stored in database 106, and may additionally be stored in an individual map database or within a general database searchable for ETA information/calculation through cross reference with traffic conditions, road density, etc.

Database 106 may also include traffic sign or signage data 444, such as traffic sign or signage location information and traffic sign or signage images from the websites of various government sources. Traffic signs that apply to a user's current location or the location of a vehicle may be automatically displayed for the user on computing device 132 after a user temporarily stops or parks in a location, or while the user is approaching or travelling through the location. Applicable traffic signs can be displayed through user engagement panel 134 and can be rated by the user, or applicable traffic signs can be displayed to the user through one or more notifications. Additionally, a concise, easy-to-understand description of the traffic rules indicated on the sign may be provided to the user so as to avoid any misunderstanding of the sign, potentially with a translation into another language or explanation in plain language.

Database 106 may also include rules and administrative data 446 as well as user data 432. Administrative data 446 may include data related to dispute resolution, quality control, etc. Historical data may be tracked in part by assigning a tracking number or service ID number that would be assigned to ticketing or related information to help refer back to it if it comes into question. Information that could be held within this identification may include the reason a ticket was issued, who or which agency issued it, where it was issued, where the traffic violation occurred, such as address-specific information, cross-street/intersection, or more generally by zip code, borough, city, or state. The information may additionally or alternatively include the amount of the fine, the manner of payment, etc.

In an alternative embodiment of database 106 in accordance with the inventive disclosure, FIG. 4B shows that database 106 may contain several data categories or groupings that establish data sets, including but not limited to non-commercial vehicle data 400, commercial vehicle data 402, data based on type of vehicle 448, data based on type of vehicle plate 456, user engagement panel data 420, user data 432, weather data 434, commercial/non-commercial traffic data 436, public/private traffic data 438, map and route data 442, traffic sign or signage data 444, administrative data 446, and traffic density or other traffic data 447. Non-commercial vehicle data 400 may further include non-commercial vehicle historical citations 404, non-commercial vehicle real-time citations 406, and rules and abbreviations data of non-commercial vehicles 408. Similarly, commercial vehicle data 402 may further include commercial vehicle historical citations 412, commercial vehicle real-time citations 414, and rules and abbreviations data of commercial vehicles 416. Data based on type of vehicle 448 may further include historical citations based on type of vehicle 450, real-time citations based on type of vehicle 452, and rules and abbreviations data based on type of vehicle 454. Data based on type of vehicle plate may further include historical citations based on type of vehicle plate 458, real-time citations based on type of vehicle plate 460, and rules and abbreviations data based on type of vehicle plate 462. User engagement panel data 420 may further include redesign of traffic signage data 422, contributed citations data 424, citation avoidance suggestions 426, dispute recommendations 428, and submission ratings 430. This organization of data in the database 106 allows for data based on type of vehicle 448 as well as for data based on type of vehicle plate 456 to be its own data set within database 106.

In an exemplary embodiment of the inventive disclosure, system 100 may be configured to only retrieve, display, and notify a user about data from database 106 pertaining to a single type of vehicle or user. For example, a taxi cab company using system 100 may configure system 100 to further categorize commercial vehicle data 402 in database 106 into taxi/cab data, to only retrieve data from database 106 pertaining to taxis, and to only include data specific to taxi drivers in its notifications to drivers of its vehicles. By way of another example, a car service company, leasing company, rental company, or other type of company which uses vehicles may configure system 100 to only retrieve, display, and notify a user about data from database 106 pertaining to two, three, four, or more specific types of vehicles owned by the company. A company which leases or rents bicycles may configure system 100 to provide users with only bicyclist related data.

It will be appreciated that some non-commercial vehicle data 400 may apply to or be relevant for commercial vehicles, and that some commercial vehicle data 402 may apply to or be relevant for non-commercial vehicles. Thus, system 100 can be configured to retrieve, display, and notify a user about data pertaining to particular types of vehicles, and/or to data which correspond more generally to numerous types of vehicles (e.g., weather data 434, commercial/non-commercial traffic data 436, public/private traffic data 438, map and route data 442, traffic sign or signage data 444 pertaining to all vehicles, administrative data 446, traffic density or other traffic data 447, etc.).

It will additionally be appreciated that certain vehicle traffic data may impact cyclists or pedestrians, and vice versa. For example, traffic rules often allow cars to turn left while pedestrians are crossing the street onto which the car is turning. In highly populated cities like NYC, such rules may be dangerous for pedestrian tourists from rural areas who are unaccustomed to encountering numerous cars and bicyclists while crossing the street, and to tourist drivers who are unaccustomed to seeing large groups of people cross a street right in front of them as they are turning. System 100 may be configured to warn such users of this potential hazard.

In accordance with certain embodiments, prior to being stored in database 106, various types of data (i.e., non-commercial vehicle data 400, commercial vehicle data 402, citations data (404, 406, 412, 414), rules and abbreviations data (408, 416), user data 432, weather data 434, traffic data (436, 438), map and route data 442, traffic sign or signage data 444, traffic density or other traffic data 447, citation avoidance suggestions 426, dispute recommendations 428, reasons for citations, etc.), may first be stored in a temporary database or other memory to allow authentication or verification of the data. This temporarily stored data may be displayed on various user engagement panels 134 of additional users, and subject to ratings by the additional users to verify its accuracy. The additional users preferably have firsthand experience with the new data or information (e.g., direct knowledge of the new data or information by virtue of having passed through a particular location associated with the new information, as identified by location identifier 204, or other knowledge of the new information). The additional users of system 100, upon approaching or passing through a location associated with the new data, may be queried or provided a notification, on their respective user engagement panels 134, asking whether the new data or information is correct. The additional users may provide positive or negative ratings (e.g., thumbs up or thumbs down), or more detailed information, through user engagement panels 134. If the new data or information receives a predetermined number of positive ratings from a predetermined number of different users, then it may be automatically entered into database 106. In other embodiments, if the new data or information receives a first predetermined number of positive ratings but also receives a significant number (e.g., a second predetermined number) of negative ratings, then an administrator of system 100 may open an additional inquiry and make a determination as to whether or not the new data or information should be entered into database 106. Once the new data or information is entered into database 106, it may form the basis for a new notification and/or additional content of existing notifications pertaining to specific locations.

Once new data or information is stored in database 106, it may be further subject to ratings on an ongoing basis. For example, if conditions change with respect to particular locations, then the new data (now part of historical data and included in notifications for particular locations), may become inaccurate. When the notifications or content thereof receive a predetermined number of negative ratings, they may be similarly updated by new data and/or removed from database 106. The accuracy of all forms of data stored in database 106, as well as notifications and the content thereof, may continually be dynamically updated through crowdsourcing and ratings as described herein.

Since different RRLC data applies to non-commercial and commercial vehicles, it results in different types of ticket violations, which may be categorized by system 100 in database 106. Users who indicate in their profile that they drive a commercial vehicle are automatically marked in the commercial vehicle category. Non-commercial vehicles include but are not limited to: passenger cars, mini-vans, SUVs, etc. Within the commercial vehicle database of the system, the type of commercial vehicle can be split into categories, including but not limited to, tractor-trailers, trucks, taxis, limousines, etc. Traffic rules applicable to commercial vehicles may not be applicable to non-commercial vehicles, which necessitates the need to separate data for different types of vehicles into different categories so that respective tickets may also be categorized depending on the vehicle and the reasons for the violation.

The system of the mobile application is preferably also configured to allow commercial vehicle users to enter ticket violation information and reasons associated therewith, which is separately divided in database 106 according to categories. Such vehicle type data can show patterns for different types of vehicles which commit the violations. Although there are two types of vehicles, their corresponding data are preferably combined and integrated in one database (e.g., database 106) in system 100. Users can be notified about different tickets that occurred at an impact zone, or with respect to isolated incidents involving single violations. The impact zone, which may be pre-set by a user, is defined by a distance from the impact location, and encompasses an area which is within a certain radius or distance of a location (or within a predetermined region associated with the location) with previously issued traffic violations. The impact zone determines whether a user receives a notification for a driving action not allowed by a certain type of vehicle within the indicated area because of any applicable rules for traffic violations. For example, system 100 may be configured such that users whose profiles indicate they are driving a non-commercial vehicle receive a notification when trying to enter a zone for commercial vehicles, while commercial vehicle drivers either do or do not receive this alert depending on settings in system 100. Notifications can thus be more accurate and applicable. Since there are different categories within commercial vehicles, system 100 can also be configured to sort and categorizes data depending on vehicle type, plate type and the issuing agency of the specified traffic violation. Such information and applicable traffic rules can be inferred depending on plate type, vehicle type and issuing agency as different traffic rules apply to different drivers depending on the types of vehicle and/or the type of plate they are driving. These rules can be categorized so that when a user registers their driver's license and vehicle information with the system when creating an account, the system will automatically be able to identify the relevant rules that apply to the particular driver and send notifications accordingly. The database may also store traffic rules with corresponding violation codes. When a ticket is uploaded to the system, system 100 may use the violation code to identify the violation and also infer the location to which it applies based on the location appearing on the ticket.

The same rules apply to the same category of vehicle or the same type of plate, which may be regulated by a specific agency. Different issuing law enforcement authorities have different rules and regulations that apply only to the vehicles they have the authority to regulate, which necessitates categorization of violation citation data based on types of vehicle and types of plate in order for system 100 to provide proper notifications to the users who may be driving different types of vehicles with different type of plates. Accordingly, the system can generate alerts as the same rules apply for the same plate type, but also analyze whether such rules apply to different types of vehicles. System 100 can sort the violation citation data into the same categories that apply to traffic rules, where each violation citation datum includes but is not limited to time, reasons, location, type of vehicle, and type of plate etc., for the received traffic violation citations. Since some rules apply to all vehicles with all types of plates, the system can send alerts to all applicable vehicles. For example, in NYC, the Taxi and Limousine Commission (hereinafter, “TLC”) regulates commercial vehicles which have a plate beginning with the letter “T.” TLC officers have the authority to issue specific types of tickets unique to TLC vehicles based on TLC regulations but do not have the authority to regulate other commercial vehicles, for example buses, which are regulated by the Department of Transportation.

System 100 may use the data to provide notifications to alert users of dangerous, accident-prone locations along the city-designated truck routes if the user must drive along those routes to arrive at their intended destination. Additionally, system 100 may also navigate users on different, less-dangerous routes when possible if the user has indicated in their profile that the user may be a senior citizen, a motorcyclist, or someone who is inexperienced in driving. Avoiding city-designated truck routes will help reduce dangerous accidents because collisions with a commercial vehicle often cause substantial injuries and deaths.

System 100 can also alert the user within a certain distance of locations of various weigh stations the user stops at if the user indicated he/she is driving a truck and/or other commercial vehicle subject to weigh station rules and regulations. As weigh stations are mandatory, this notification helps users know of the existence of the weigh stations so the user properly stops for an inspection. The application can also provide alerts that include but are not limited to, weight limitations, size limitations, cargo restrictions, height limitation or clearances, hazmat restrictions, hazardous materials restrictions, etc. This is helpful for all commercial vehicles since the driver can be alerted to routes that do not restrict commercial vehicles.

Due to the complexity of traffic rules, it is often very difficult to determine which actions are legally permitted in a given location at a particular day and time. Drivers wishing to abide by traffic rules carefully examine signage that posted over lanes of traffic and at intersections. However, traffic signs and lane markings are sometimes not easy to identify or interpret quickly, especially when the vehicle is in motion. Additionally, traffic signs and lane markings are sometimes partially or fully worn or obscured. Thus, even the most well-intentioned drivers inadvertently commit moving traffic violations.

Exemplary embodiments of the inventive disclosure provide a platform for the collaboration and sharing of information regarding traffic citations. There are usually two types of tickets: a handwritten/machine generated ticket from a law enforcement officer or a machine generated ticket from a street camera image. Different law enforcement agencies use different forms for ticket violations. The person who receives the ticket may be in the best position to submit suggestions, advice, and/or solutions based on their personal experience to advise other users on how to avoid such traffic violations in the future.

Different types of information are inferred by using ticket information containing the violation code. Since violation codes are different depending on the agency that issues tickets and collects ticket penalties, violation codes data input into system 100 can includes violation codes from various agencies and/or statutory codes as they appear when written into law. For example, in New York City, traffic tickets state the Department of Finance Violation Code as “07”, which means “vehicles photographed going through a red light at an intersection,” and state “In violation of NY Vehicle and Traffic Law, Title 7, Article 24, S 1111, Section (d) Obedience of Traffic-Control Red Signal Indications”. System 100 can use these violation codes with the matching section codes and their respective meanings, which can be stored in database 106, to infer, for example, that the time frame to which the “No Left Turn” rule applies as “No Left Turn” is usually for 24 hours. The system of the mobile application can use this information to accurately alert the user based on the vehicle's distance and time frame in advance by inferring time restrictions/time sensitive (“timeframe”) rules based on the violation. Similarly, the above inferences may be applied to no stopping zones which are typically in effect for 24 hours. The system can infer that a ticket for a location with the reason for the violation is a no stopping zone, and can apply this rule as in effect for 24 hours so users will receive notifications to alert them to this potential violation. Different violations with time restrictions may be applied in this manner.

For example, the steps involved with inferring time and location data for traffic violations may include (1) system 100 receiving ticket information from a user who uploads the information, (2) the ticket information including several types of information such as time of the violation, location, violation codes, description of violations, and other user or vehicle identifying information, (3) storing this information in the database, (4) the ticket stating that the violation was for stopping a vehicle in a “No Standing Zone”, (5) the reason being entered into the system along with the location (e.g., Flushing, N.Y.) where the violation took place, (6) the system inferring from this information/data that the location has a no standing zone sign which typically in the location Flushing, N.Y. is a rule in effect for 24 hours a day, (7) the system inferring and storing the information that the particular location in Flushing, N.Y. is a “No Standing Zone” in effect for 24 hours per day, and/or (8) users receiving notifications when they are within a certain distance of or are located within the location with the no standing zone violations.

A present time and a present location of a user may be cross-correlated, according to the user's user type, with the traffic violation data in database 106 to predict or infer a potential traffic violation at a location the user is or will be approaching. A potential traffic violation can thus be predicted or inferred for the location where a traffic violation previously occurred, for example, when the violations were within the same time frame of a day or in the same month of a year as the current day and time for the user. A data processing apparatus may be employed to cross-correlate an identified or current location of a user with a time and a location of each of the violations to predict a likelihood of a potential violation at the location the user is approaching, at the same time and/or day of the year.

In addition to digital maps, system 100 may utilize statistics to predict future traffic violations. The statistical analysis of traffic violations may be carried out periodically for certain locations, which may aid in finding measures to effectively decrease the rate of traffic violations. By studying the statistics of traffic violations for specific locations, it may be possible to predict with reasonable accuracy, the probability of future violations at the location, or even the threat the location poses to other user types, such as pedestrians, based on the type of violations. Factors such as time of day, and grouping the risks may also help with the differentiation process. For example, users classified as a “High-Risk Driver Group” may see a “red zone” on computing device 132 when approaching a certain location, indicating a higher chance of committing a traffic violation for such users. Conversely, users classified as a “Low-Risk Driver Group” may see an “orange zone” when approaching the same location, indicating that the probability of committing a traffic violation is moderate instead of high. Actuarial parameters that may be used to classify users to different risk groups include, but are not limited to, age, gender, occupation, education, disability status, height, weight, eyesight condition, city of residence, state of residence, nationality, marital status, driving history, etc.

The traffic violation data may be processed from various sources, including, but are not limited to, the government, government agents, municipalities, non-government organizations (NGOs), private entities, community organizations, interested individuals or users, websites containing useful information such as law enforcement abbreviations, blog posts, social networks, newspapers, professional articles, publicly available sources, and any other resources where historical traffic violation-related data is collected etc. (hereinafter, “informational sources”). Some of the traffic violation data is provided as public open data from the government agencies and is also available through a request from the Freedom of Information Act if not available through public government websites. However, when no open government traffic citation data is available, the system obtains historical traffic citation data through the input from the users and/or interested individuals. An administrator of the system also collects traffic citation information from private entities, for example, transportation companies, or any other organizations that specialize in transportation having access to issued traffic citations. The database utilizes a collection system and method for collection of information regarding traffic violation related information from the Informational Sources. The other information from newspapers, blogs, magazines, etc. is collected and summarized by an administrator or employee of system 100 to supplement database 106. This collected traffic citation data is also supplemented by real-time crowdsourced ticket information from the users.

Another source for traffic violation citation related data is obtained by connecting to relevant government or law enforcement websites that store traffic citation information on the specific user. For example, some state Department of Motor Vehicles or Bureau of Motor Vehicles websites maintain a database of motorists, including their convicted traffic violations. Through this connection, the users check their unpaid pending ticket information through the mobile application. Additionally, the system can obtain authorization from the user to automatically search for existing violations, whether pending or unpaid, for the user by using identifying information. If there are any violations which are still pending or unpaid, then system 100 can send a notification to the user about their currently unpaid pending violations. With the authorization from the user, the system stores the information from these violations supplied as data in the historical database to further build the updated comprehensive database to alert other users with the reasons and summary of the historical violations, etc. to avoid future violations.

The government data is available through the applicable authority's website and/or publicly accessible open data. Although locations from government data regarding ticket information are not as accurate as geolocation coordinates, but still it is useful because it provides citation data in the major parts that are credible and resourceful. Therefore, locations from government citation data is transformed to geolocation coordinates through various third-party software, e.g., Smarty Streets™, which is a location geocoding service for latitude and longitude coordinates provided by SmartyStreets, LLC, before the citation location data is input into the database of the system.

The system and method of the inventive disclosure integrates a vehicle's GPS for detecting the location of the vehicle and an accelerometer to identify the state of a vehicle output, vehicle's registration information, such as state of registration, database for storing map data, traffic regulation data or penalty data, traffic violation data, user information data for storing personal information of the user, means for determining whether there is the possibility that a user commits traffic violations based on the vehicle registration information and traffic regulation data, means for issuing a traffic violation warning in case there is the possibility that the user commits traffic violations, means for determining whether a user has committed traffic violations based on the vehicle registration information and traffic regulation data, and means for storing traffic violation details in the traffic violation database in case the user has committed traffic violations, etc. The historical data is updated with real-time crowdsourced data.

The systems and methods described herein can integrate an electrical/digital map of the mobile application on smartphone/web-based/storage media. With this integration, the roadways are displayed from the map database, which presents the analyzed data as to the location and explanations of ticket violations that are easily understood by the user.

System 100 can connect internally with various functions of a mobile device, including a clock function, phone call function, microphone, GPS tracking for geo-location mapping, and/or camera, etc. The mobile application runs on the mobile device and utilizes resources which include microprocessor, memory, GPS, wireless connection and display. Notifications are accomplished through one or more media such as the visual display or audio system, etc.

Preferably, the location identifier is a Global Positioning module installed in a mobile device or a vehicle along with an accelerometer. The location identifier and the accelerometer are wirelessly connected to or operatively associated with database 106 and the data processing module. Mobile devices 132 comprise an internal clock mechanism to identify a current time and date. The location identifier and the accelerometer are connected to the data processing module through either a wired or a wireless medium.

The central server may further comprise a microprocessor and a server readable program storage medium. The program storage medium may be non-transitory and tangible in nature. The program storage medium may embody a program of instructions executable by the microprocessor to search and update a historical traffic violation data in a geolocation and assist in avoiding traffic violations.

The integration includes utilization of vehicle equipment, for example speedometer, accelerometer, cameras, GPS sensor, and any other applicable equipment, etc. The utilization of this vehicle equipment is used to obtain comprehensive real-time and historical activity information about the vehicle, for example its direction, speed, orientation and acceleration, etc., to issue applicable alerts to the users.

The mobile application alerts the user to avoid the traffic violation ticket by notifying the user through email, text message, phone call, phone alert, voice mail etc. automatically at the choice of the users who set this in advance in the settings of the system. Functionalities within the system of the mobile application, notably the user reporting function, may connect to third party APIs to provide voice-to-text capabilities. The users who utilize the voice-to-text function record their voice by speaking their statements into the microphone of the mobile communications device, which the system changes to text within the mobile application. Accordingly, the users not necessarily have to enter information manually and submit information to the system by recording their voice statements.

Since the built-in microphone on most mobile devices is not strong enough to record voice prompts from distances that are not in close proximity, the system of the application can be paired with a separate speaker attachment/apparatus. This separate speaker attachment/apparatus physically connects to the mobile device and as a result, enables the system to pick up voice prompts from further distances. Therefore, the separate speaker attachment/apparatus allows the user to speak voice prompts up to a certain distance.

The alert system may include a server, database, and user engagement panel configured to receive and process reports from the users' networked mobile devices. System 100 may process information reported from users who enter such information and upload images of their ticket violations. While ticket information is processed and used to create/update notifications, ticket reporting from the users is also connected to a ticket sharing user engagement panel. After receiving this ticket, the user can open the mobile application and press a button to report the location of the violation. The user can identify the type of traffic tickets to be reported from a menu of available pre-determined types. A multi-level menu system may be used to guide the user to a selection which identifies the type of possible ticket type. The server receives the report and the user's geolocation and determines additional contextual information provided by the user and/or the user's mobile phone from the stored user profile. System 100 can also collect user supplemented information, including personal knowledge and/or ticket information with the time of the violation, the exact location as printed/written on the ticket, the reasons for the violation, etc. Users may also be required to enter information such as photographs, videos, and written explanations to share their ideas on why the violation occurred in a form associated with the traffic violation location.

It will be appreciated that an abundance of alerts may create the possibility of a user receiving too many alerts while traveling to his/her destination. Therefore, system 100 preferably allows the user to turn these alerts on or off, through voice prompts and/or manually in the settings as described further below, depending on user preference. Voice prompts may be utilized to do so when a user is driving. When not driving, the user can turn alerts on or off manually in the settings of the application on their mobile devices or on the application's website in accordance with the user's preferences. If a user switches alerts to off, then system 100 may still allow the user to switch it back on when he/she starts on another route.

Exemplary embodiments of the inventive disclosure provide a platform for the collaboration and sharing of information regarding traffic citations. However, when no open government traffic citation data is available, the system obtains historical traffic citation data through the input from the users and/or interested individuals. An administrator of the system also collects traffic citation information from private entities, for example, transportation companies, or any other organizations that specialize in transportation having access to issued traffic citations. The database utilizes a collection system and method for collection of information regarding traffic violation related information from the Informational Sources. The other information from newspapers, blogs, magazines, etc. is collected and summarized by an administrator or employee of the system to supplement the database. This collected traffic citation data is also supplemented by real-time crowdsourced ticket information from the users.

Because of the complexity of traffic rules, it is often very difficult to determine what actions are legally permitted in a given location at a particular day and time. The drivers wishing to abide by traffic rules carefully to examine signage that is posted over lanes of traffic and at intersections. However, the traffic signs and lane markings are sometimes not easy to identify or interpret. Additionally, the traffic signs and lane markings are partially or fully worn or obscured. Thus, even the most well-intentioned drivers inadvertently commit moving traffic violations.

Exemplary embodiments of the inventive disclosure provide various methods and systems for tracking a time, date and location of issuance of the traffic citations and alerting users of their proximity to such locations on their approach. In this way, the exemplary embodiments of the inventive disclosure save users from incurring costly citations while helping to ensure safer roadways and help preserve the normal flow of traffic.

Exemplary embodiments of the inventive disclosure analyze the comprehensive database for statistical patterns regarding traffic violations that are used by the users. Exemplary embodiments of the inventive disclosure also utilize data related to commercial vehicles to assist with proper navigation, violation prevention and accident prevention with non-commercial vehicles. The inventive disclosure also utilizes a specialized incentive structure to promote participation resulting in successful real-time crowdsourced data. Analyzing the right data to discover patterns on the reasons for traffic violations and providing timely notifications of the reasons produces safer streets by reducing and/or preventing traffic violations through education and awareness.

Exemplary embodiments of the inventive disclosure also provide a system and method for the provision of an alert of the potential violation of traffic law, rules or regulations where a server is configured to send the alert to a mobile device when it indicates the mobile device is traveling towards a location with potential or previous violations and also sends alerts in advance within a preset and/or predetermined distance, such as, for example, 50 or 100 feet, to avoid violations of traffic law, rules or regulations. An accurate database is used to provide an understanding of all the rules applicable to their surroundings according to the type of vehicle and type of plate, which results in potential reduction of violations and accidents. By placing a focus on using ticket information which contains information about the law, the system finds patterns and also explains how the rules, regulations and/or law are applied to the road conditions in real situations for specific locations.

Oftentimes, certain locations are traffic ticket/violation prone due to a specific set of circumstances such as confusion over the rules specific to that roadway/intersection and/or more aggressive enforcement efforts. A user is mostly not able to effectively avoid the traffic violation tickets and other driving situations solely by relying upon existing signage and roadway markings. The exemplary embodiments of the inventive disclosure therefore provide alerts, such as actual reasons/causes for the issuing of a citation for a traffic violation so that the user who receives the alert to avoid committing the same violation.

The exemplary embodiments of the inventive disclosure crowdsource information about traffic tickets that were reported by users and/or collected by the system administrator. The crowdsourcing is a distributed problem-solving method that utilizes online and offline resources to compile services, ideas, and/or content by the solicitation and/or capturing of data from a variety of people native to a special community that is targeted by the crowdsourced subject. The crowdsourced information is used in gathering data that is current, updated, and readily available in real-time to provide firsthand information through personal knowledge and/or experiences. The crowdsourcing is also effective in gathering information that is not provided or not timely provided by the government. However, crowdsourcing citation data is costly as the users share their experiences after incurring the costs of ticket violations.

For the purpose of crowdsourcing traffic related information, the system includes a central computer system connected to the internet as described herein, with the plurality of mobile devices capable of determining their geographic locations according to geo-location and transmitting ticket-related information into the central computer system. Computer system 100 continuously maintains database 106 which stores the crowdsourced data along with data received from various informational sources, analyzes the user reports, detects patterns for locations or possible individual isolated violations at locations, and provides real-time alerts to a plurality of users connected to a network through their mobile communication devices. Each input is assigned a unique tracking number and this unique number is transmitted to the remote server accompanied by the current position of the user/mobile phone.

The preferred methodology disclosed herein includes an incentive methodology relating to database 106 incorporating crowdsourced data from users. The crowdsourcing methodology relies on participation of a large number of people who are incentivized for their participation. The incentive methodology allows users to post and share their information in the mobile application to gain credit, which, at a certain amount, is exchanged for the full or partial amount to cover the ticket received by the user. In this manner, the user is rewarded based upon the user's proactive effort to report their ticket information with efficiency, helpfulness, and accuracy. When the users receive tickets, they have the option to dispute or pay the ticket before the deadline, and is allowed to obtain endorsements for rewards after the ticket information is complete and submitted. When the user shares his/her ticket information as early as possible, he/she has a better chance of gaining more endorsements and a reward to help pay the ticket violation. An additional credit bonus may be issued for users who share their ticket information as soon as possible to send out the proper notifications to alert other users. The user is required to report and share all the information requested to qualify for the system to pay for his/her ticket, and receives endorsements from other users based on the information.

Tickets issued by law enforcement officers indicate a date which serves as the deadline for paying the ticket violation. As an incentive to users, the system of the mobile application can use a method of rewarding efficient and useful reporting to help users pay for their tickets through a reward system. The incentives are crucial to obtaining both active participation from users and also for obtaining accurate and truthful information. Active participation is important because accurate statistical analysis depends upon a large amount of data, and it is important to continuously obtain real-time data reflecting current situations.

As the system of the mobile application records and stores accurate geolocation GPS coordinates of the mobile device, the alerts sent to a user may be customized and localized to the user's location within a certain region, which represents the impact zone. Since the database stores and analyzes RRLC data from different municipalities and/or other authorities, the system matches geolocation and applicable RRLC data to send notifications according to the user's location or a location indicated at a user's request. This function is useful for the users who drive across state/country lines and are unfamiliar with the RRLC data from the different states/countries. The system of the mobile application has the user's driver license information as the user enters and store the information of the driver license with the state/country who issued the driver license when registering a user profile. Using the location from where the user's driver license was issued with a user's current geolocation data, the system of the mobile application sends alerts for different rules or a summary of differing traffic rules to the user according to the geolocation as it changes. The users press a button on the display of the mobile application to view the summary of the different traffic rules when comparing the location that issued the user's driver license with the user's current location or any location requested by the user. This method is not only applicable within the different states of the United States of America but also between different countries worldwide. The term Geolocation may be described as the identification of the real-world geographic location of an object, such as a mobile phone or Internet-connected computer terminal.

Exemplary embodiments of the inventive disclosure add to the database by using information as reported by the users to update, verify and supplement the database from government data to build the database. Exemplary embodiments of the inventive disclosure continuously collect, analyze, and update the various citation data to build a more accurate, up-to-date database. The system and method include an incentive structure paired with an administrative quality control center to ensure the data quality and reliability of the data analyses and the information dispersed to the users.

The raw traffic ticket citation data obtained from informational sources is uploaded to a computer microprocessor and formatted to include only relevant information needed for running analyses and providing notifications. The uploaded citation data is then split into two sets for cleaning and uploading into the system's server. The first set is citation data which is already verified as having all the necessary information in the right format while the second set is a citation data which needs to be reformatted to include all the necessary information. Once all citation data has been cleaned, the address data is extracted in a data frame to be used in a third-party geocode API, for example, Google Geocoding API™, which is a location geocoding service provided by Google Inc., SmartyStreets™, etc. to output a .csv file with all the geocoded information of locations relative to each ticket. The output is reviewed and corrected by the system administrator for accuracy and completeness.

The traffic signs data and RRLC data files are also be uploaded, cleaned and merged with the citation data into the database. The sign and road marking information are necessary to indicate the existence of bus lanes, U-turn signs, and school zone speed signs, including limited locations that may be obtained from government websites, or if not available through the websites, may be reported by the users or collected by the employees of the system or third parties hired to collect such information. These road conditions are all indicated with special markings and/or signs. Therefore, these images are entered into the database in the relevant location, which allows the system of the application to provide notifications to the users regarding the existence of these road conditions and information to avoid any violations while driving in the location.

The raw data entered, processed, stored, and analyzed includes but is not limited to: a type of violation, the causes/reasons for the violation, a name of the law enforcement officer who issued the ticket, the officer's comments on the ticket, a registration state, a plate type, a vehicle type, an issue date, a violation code, a violation statutory code, an issuing agency, a violation time, a house number, a street name, law section, a sub division, a violation legal code, time and date when the traffic rule is in effect, description of the violation, and/or any other relevant factors, etc. The reasons for traffic ticket violations include but are not limited to: distracted driving (e.g., phone call, texting, eating), speeding, driving under the influence, reckless driving, disobeying traffic control devices (i.e., running red lights), running stop signs, road defects, unsafe lane changes/failure to signal, wrong-way driving, improper turns, tailgating, drowsy driving, deadly curves, and roadway signs (e.g., being obstructed), driving in bus lanes, violating rules of the road, illegal U-turn, violating car registration/driver's license requirement, failure to show proof of insurance, use of truck restricted route, etc.

The system may integrate a verification algorithm to detect duplicate data if the tickets issued on dates and times that match those in the database are labeled as duplicate data, which is automatically rejected. However, the tickets issued on dates and times not included in the database are added to the historical database and notifications are updated to properly reflect added data to properly alert the users with updated information.

The database also includes other types of publicly available useful and critical resources, for example, abbreviations and their common meanings as used by law enforcement. The law enforcement officers often use abbreviations when issuing tickets. On the ticket, the abbreviations appear in the area where the officer specifies the violation and/or location of the violation. The abbreviations are processed and stored in the database by gathering data from publicly available sources to provide the most accurate and up-to-date meanings. The users are able to check the language by using the system to automatically change the abbreviations to plain English meanings according to their location when typing them into the mobile application. The function is also used when a user reports his/her ticket that contains abbreviations. The user for example, types the abbreviated language into the mobile application when reporting, and then the system automatically changes the abbreviations to their plain English explanations and converts the address into a geolocation. For example, tickets with confusing abbreviations, “N/W Hubbard St. 5 ft N/of Ave. Z” would be changed to “North West of Hubbard Street five feet North of Avenue Z” and then used to create the accurate geolocation through a third-party's geolocation API to be entered into the database. The geolocation is then used to alert other users. The users earn rewards if they report any incorrect or inconsistent abbreviations and the system administrator verifies and corrects the information.

The database also includes traffic sign information, such as traffic sign location information and traffic sign images from various government sources (e.g., Department of Transportation, hereinafter “DOT”). If the user does not understand the sign at specific location or has any questions, he/she presses the button to open the user engagement panel connected to the location where the user reports the sign information and views any exchanged information from other users for this sign that is connected to the current location, if such information is available through the system. If traffic sign information is not available from the government sources, the user may choose to submit traffic sign information for the applicable traffic signs and the user would qualify for rewards, and/or have an employee sent to the location to obtain this information. The traffic sign image notification includes a rating system so the user may rate or indicate inaccurate information if there are errors or missing signs.

The database also includes information that contains details on types, locations, timings, sequences, etc. for traffic signals. This information is obtained through open sources from different jurisdictions and third parties API's, such as for example OpenStreetMap™. The traffic signal information is used to reduce red light violations by informing drivers when the traffic light is about to change or about Red-Light Camera locations. Red-Light Tickets and Red-Light Camera Tickets are the second most common moving violation ticket. In New York, fines for running a New York red light depend on whether the ticket was given by a law enforcement officer or by a camera and may range from $50 for the first offence to $400 for the 3rd offence in 18 months.

Another method for preventing violations within a school zone relates to the existence of speed cameras within a school zone. Alternatively, any type of traffic enforcement camera (e.g., red light camera, road safety camera, road rule camera, photo radar, photo enforcement, speed camera, safety camera, bus lane camera, etc.) may be employed beside or over a road or installed in an enforcement vehicle to detect traffic regulation violations, including speeding, vehicles going through a red traffic light, vehicles going through a toll booth without paying, unauthorized use of a bus lane, or for recording vehicles inside a congestion charge area. There are two types of speed cameras that exist within school zones—stationary and mobile, installed in law enforcement vehicles. The stationary speed cameras stay in the same location where they are installed. However, mobile speed cameras move in accordance with the law enforcement vehicle. Information regarding the geo-location GPS coordinates of a school building (public, private, or any other type of school building) may be input into a database. The location data is available online in some locations, which is easily input into the database. These coordinates serve as the basis for notifications within a certain region to be set by the administrator according to the RRLC data. A user is sent notifications alerting them if they are within 1 mph or 2 mph of the allowable speed limit according to the user preferences and/or when they are already driving over the allowable speed limit. Although the current systems notify the users as to the location of a speed camera, this information is useless if the user is already speeding within the camera's reach.

Also, mobile speed camera locations can change; therefore, it is better to notify a user within a certain region associated with the school building regardless of the direction the user is traveling. For example, the RRLC data in New York states that the speed camera may be within a quarter-mile (¼ mile) of the entrance or exit of a school building and also on the same road as such entrance or exit. The RRLC data in New York also states that the speed camera can actively operate up to thirty (30) minutes before the opening and thirty (30) minutes after the school closes. However, many schools in New York for example, conduct pre-school activities and/or after-school activities and therefore the general hours at which a school may operate between 6:30 AM to 7:00 PM. The data regarding this time frame may be input into the database. The speed limit around the school building may also be input into the database. According to New York's RRLC data, the speed camera issues a ticket when the vehicle is traveling at 10 mph or up over the posted speed limit. The administrator sets a 0.1 mile distance within the geo-location GPS coordinates of the school as the applicable area in which the user should receive notifications.

The system is then able to send a notification when a user is within this 0.1 mile distance of a school and within 1 or 2 mph of the allowable speed as set by user preferences. A predetermined distance or region methodology is used here because simply tracking the geo-location GPS coordinates is not enough since the notification or alert appears too late when the user is already within the capture distance of a speed camera. The user may set a certain distance for notifications to appear. For example, after 10 meters, the user may wish notifications to alert them of speed capture cameras 30 meters in advance. Similarly, the user may select a predetermined amount of time in advance for the notification to alert them. For example, the user may elect to be notified one minute in advance, or 30 seconds in advance. As a result, a user does not have to worry about the existence of stationary or mobile speed cameras since the user is alerted to the speed limitation and may avoid a ticket violation if they follow the information provided in the notification. The stationary or mobile speed cameras are not limited to school zone areas and exemplary embodiments of the inventive disclosure may be used to alert users of any speed cameras in other applicable areas. The system provides alerts in advance of potential speeding and also provides alerts when already speeding. This concept also encompasses red-light cameras. Red-light cameras are stationary and record an image of the vehicle as it passes through a red light. Tickets may be issued for violations of running a red light. The system will store locations of red light cameras and will provide indicators of red-light camera locations in different formats, such as colors, shapes, and lines, etc. The user may select a predetermined amount of time or a predetermined distance in advance of approaching a location with a red-light camera for the notification to alert them.

The system preferably provides alerts in advance of speeding (e.g., where a speed limit changes or is reduced) and also when a user is already speeding. The system may also be configured to allow the user to set the number of miles over the speed limit for a certain location in which the notification may appear. Therefore, the user may set, for example, fifteen (15) mph over the speed limit before the application notifies the user that the user is driving too fast. The user can also change this amount in the settings of the application in case the user would like to lower or increase the amount. This notification may also include an alert to the user regarding suggestions, advice and/or solutions on how to avoid receiving another traffic ticket or committing another traffic violation for speeding. This example regarding a user who is prone to speeding may also be applicable in situations where the user drives excessively under the speed limit, which can also be dangerous to other drivers on the road. The system preferably allows the user to set the number of miles under the speed limit at which the notification about under-speeding appears. This number may be adjusted in the settings of the application according to the preferences of the user. In the event the mobile device is outdated and/or does not possess an internal speed tracking system, the user attaches a separate apparatus, the “speed processor” which connects with the application to accurately track and record the user's speed.

Preferably, the system users are able to establish any number of preset or predetermined settings to provide full or partial customization of the features of system 100, such that, for example, the content of notifications, the timing of receipt of notifications, the distance within which to receive notifications, the appearance of notifications, the data types and/or user types for the notifications, etc., may be preset as desired by the user. Alternatively, all or part of these features or configurations may be set by default if not preset by the user. Preferably, the user is able to set these features or configurations in the settings of the application. The user may also be allowed to change these presets, for example, distances, at their discretion through a voice prompt and/or manually by returning to the settings of the application. For example, an elderly user may wish to receive notification of a change in speed limit further in advance than a young user (e.g., twenty seconds in advance of arriving at a location where the speed limit changes). System 100 can calculate or estimate, based on the user's speed and geolocation, how long it will take the user to arrive at the location where the speed limit changes, and thus generate a notification in sufficient time in accordance with the user's presets. The system of the application uses voice recognition software, which connects to the microphone in a mobile phone, to allow the user to turn off the notification or to otherwise communicate or interact with the system orally or by speaking a voice prompt within a certain number of seconds after such notification appears, such as “shut off”, “please turn off”, etc., if, for example, the user does not want to be notified of the same message again. The reasons a user may not want to be notified again include, but are not limited to: familiarity with the area and/or location, a high frequency of the same type of notification, etc. To avoid the negative impact of the user being bombarded with too many notifications when using the application, a voice prompt allows a user to instruct the application to cease providing certain notifications, whereby the user can sort and customize his/her settings. The system of the application is able to recognize the voice prompt through its voice recognition software and turn off particular notifications associated therewith. Also, through this voice prompt, the system of the application knows it should not provide the same notification to this user in the future. The user may alternatively turn off particular notifications manually when he/she is not driving. If the user changes his/her mind and would like to receive particular notifications again, the user can manually turn on the notification feature again for that type of notification within the settings of the application. With this customization, the application only notifies and/or reminds users of things a user wants and/or needs to know.

Other functions of the application which connect with the time function of a mobile phone involves time related regulations such as idling penalties for having the vehicle's engine running in a certain location while stationary. In some areas, such as New York for example, drivers are issued a violation ticket for idling for over three (3) minutes in a location that prohibits idling. The ticket penalties for idling in New York can range from $100 to $2,000. To prevent the user from receiving this type of violation, system 100 connects with the internal time function of the mobile device in addition to the geo-location system to verify the time and exact location of the user. The administrator of the application has entered specific RRLC data into the system's database. When a user is stationary for a certain amount of time, to be set by the administrator of the application, as determined by the GPS geo-location and internal clock functions of the mobile device, the system of the application automatically records the user's location through GPS location functions, and searches for any applicable time related restrictions in addition to starting an internal timer to record the amount of time the user has been stationary. The system searches the relevant database information for RRLC data about how long a vehicle has been idle at that exact location. After tracking the time, the system then sends a notification to the user with related penalty information once the user exceeds the time allowed to be idle at that specific location. The notification triggers the attention of the user, and the user can then decide to move the vehicle to mitigate the risk of receiving an idling violation ticket. In this manner, the system helps users avoid penalties while also keeping the environment clean since users are less likely to idle for long periods of time and may decide to park elsewhere instead.

Another method of determining whether a vehicle is idling concerns the usage of a sensor that connects to the vehicle's engine to be able to tell whether the engine is on or off. If the engine is on then the internal timing mentioned above tracks how long the vehicle has been stationary and provide notifications to prevent idling violations. A speed sensor, accelerometer or the GPS can each be used to determine if the vehicle is moving or idling. Once the system determines a car is not moving, the internal timing starts running to record the amount of time the car is idling. If the engine has been shut off, this signals that the vehicle is in park mode. One issue with this method is that a vehicle could be stopped at a red light. To resolve this issue, the system tracks the timing of the vehicles stationary status, speed and location. If the user is in stationary mode for more than one minute, then the system automatically starts to track the time in the event there is a potential idling violation. Since the system integrates a road map in the database, if the vehicle is on a road, the system also recognizes this through the geo-location GPS coordinates to identify the users' location since different jurisdictions may have different idling rules. For example, in NYC a vehicle other than an authorized emergency vehicle, that is parked with its engine running for more than three minutes, or parked next to a school with its engine running more than one minute, is committing an idling violation, whereas under New York State law, vehicles may not idle for more than 5 consecutive minutes.

The application is not limited to the alerts described above. Other functions of the application relating to alerts include but are not limited to bus lane and any other potential traffic violations, etc. The bus lane is a travel lane restricted to buses only during certain hours of the day. During this time, other vehicles may enter a bus lane only to make the next available right turn, or to quickly drop off or pick up passengers. Violating a bus lane rules results in a $115-$150 fine. NYC enforces bus lanes in two ways through bus lane cameras and police enforcement. The city has installed cameras along bus lanes to catch violators. The signs are posted along routes that have bus lane cameras as an extra warning for drivers to keep out of bus lanes, except for allowed right turns and passenger pick-ups and drop offs. The police enforcement or NYPD regularly patrols bus lanes, and issues moving violations to bus lane violators. To help the users avoid bus lane violations, the system may inform the users in advance when they are approaching a bus lane. The bus lanes are identified on electronic maps through colors. For example, the bus lane sign says that entering the lane is prohibited between 7 AM and 7 PM. In that case, the system marks the bus lane area in red color to inform the user that entering is prohibited. The bus lane information is obtained from government websites and updated through traffic citations, the user reports or employees of the system.

According to an embodiment herein, different formats are used to identify the density of issued traffic violation citations at specific locations or for broad or narrow geographic areas, such as a borough, block or street. The format further identifies a plurality of fluctuations in number of issued traffic violation citations reflected at specific locations based on the time of the day and historical traffic violation summary data for said location at time of the day. The users of commercial and/or non-commercial vehicles view different identification maps. Thus, the users of the application are able to know whether there is a potential violation at a particular location in advance even before the user starts the trip so as not to break the rules and not to be issued a traffic ticket. Therefore, the traffic ticket violations are substantially reduced by the users of the application who are able to share their traffic violation ticket information, suggestions, advice, and/or solutions through this application.

In addition to other indicators or other formats, such as colors, shapes, voice notification, text message are used to identify violations with time restrictions. The time restriction is a time frame where certain actions, such as for example, turning right or left, is not allowed within a certain location, which may be used to help the system produce time sensitive alerts when applicable. The data reflects an accurate time frame for these violations rather than track each time as its own specific instance of a violation and notifies the users about the entire time frame when specific actions, such as, for example, turning, is prohibited, and not just a specific time point as indicated on the ticket.

In certain embodiments, a user may interact with user engagement panel 134 through an electronic touch-sensitive screen on a mobile device (e.g., computing device 132) or may use any other interactive computing device. Any other potential term may be used to describe this function, such as “user interface”, “forum”, “discussion group”, “online meeting”, etc. User engagement panel 134 may be used by one or more users, other individuals, or entities such as the government, government agents, municipalities, non-governmental organizations, private entities, community organizations, and/or media sources. User engagement panel 134 allows a user to upload his/her traffic ticket violations, and other users can give positive or negative ratings depending on the accuracy of the information provided. The data in database 106 may be updated, corrected, or supplemented to reflect new traffic violation related information, which may lead to a corresponding notification being updated accordingly. Once the notification receives or reaches a predetermined number of positive ratings, thereby confirming that the data conveyed by the notification is correct, the user who shared that new traffic violation information may receive a monetary or non-monetary reward. Additionally, user engagement panel 134, for at least one specific location and at least one specific time or time frame, may be configured to allow at least one user to provide content associated with traffic violations, provide explanations of traffic signs, obtain suggestions to clarify meanings of the traffic signs along with a rating corresponding to each suggestion where the suggestions have a top rating appearing on top of a list, gather information relating to the traffic violations, provide content to clarify at least one reason for receipt of the traffic violations, provide responsive information relating to avoidance of the traffic violations, provide at least one of: plain explanations, multiple language translations, or requests for redesign suggestions of confusing traffic signs to clarify their meanings, and/or provide a street view to enable at least one of photos, comments, or videos for locations having a predetermined number of traffic violations.

In certain embodiments, user engagement panel 134 may be preset to focus on a particular area, such as a user's identified current location. When a user opens user engagement panel 134, the content that may automatically display may be based on the user's preset location. A user who receives a notification may click on a notification to access more details about a potential traffic violation. If the user is still not satisfied with those details, then the user may use the user's computing device 132 to connect with the user engagement panel, where the content that automatically displays may be information in even greater detail. This content may include traffic signage, and the user may submit a question to the user engagement panel based on the user's specific location. However, user engagement panel 134 may also provide access to content in other areas. For example, this may be a user in New York who intends to rent a truck to move to Florida. The user might like to see parking or traffic violation related data applicable to a certain area where the user intends to unload the truck. Since the truck is usually considered a commercial vehicle and different states might have different regulations regarding traffic violations and/or parking violations (e.g., unloading a commercial vehicle in the street), it might be convenient for the user to get familiar with traffic violation related data applicable to that certain area prior to the move to avoid receiving a traffic violation related citation.

Preferably, the user can preclude a single notification, part of a notification, or an entire notification. In addition, the user can specify to not see any image of signage, instead opting to see simply a short description of the signage. In another example, a user who travels often in the same area each day could specify that the notification relevant to that location does not need to be displayed each day, as the user may be very familiar with the rules. Whole or parts of notifications may also be configured for turn-off. If such violations do occur and the user attempts to contribute traffic violation data regarding it, a system administrator may preclude this data from being added to the database, or certain traffic violation data may be precluded automatically. It will be appreciated that this is merely an example, and not intended to limit what information does get incorporated into database 106. Preferably, the central notification issues reminders on nights and weekends but is turned off during working hours or during the week. This is, however, an example and not intended to limit in any way the time customization that users can specify with regard to which notification is issued, nor is it intended to limit which information is incorporated into the database.

In preferred embodiments, the system is configured to allow the user to do a general search for violations in specific location(s) using the user engagement panel to access system 100. If the search does not result in an answer that satisfies the user, then the user has the option of posting his/her own inquiry through user engagement panel 132, in connection with a specific location. By educating users through sharing their own experience, other users are more conscious of their driving actions, which also helps avoidance of receiving tickets and/or overall reduction of traffic ticket violations. All functions of the mobile application, such as notifications and the user engagement panel, are available in different languages that can be changed by the user. The system uses a third-party service and/or API, for example, Google Translate™, which is a language translation service provided by Google Inc., or the administrator of the system may hire professionals and competent translators to translate the content to different languages or provide explanations in plain English or any other language. The users also translate information, which is subject to ratings.

User engagement panel 134 may have functionality that may incorporate two aspects: a user engagement panel connected to the specific location(s) of violations on the electronic map of the system of the mobile application, or a general user engagement panel where users can discuss general ideas not related to specific locations. The user presses on a location related to traffic violations within the map display to choose “User Engagement Panel,” to access the user engagement panel function which includes different categories where information may be exchanged between the users, such as tickets sharing; questions or answers or comments; traffic signs; and/or any other different category not included in the above, if any. The tickets sharing category allows a user to view comprehensive, detailed information for the location applicable to the ticket violation including but not limited to a copy of the ticket without sensitive information, reasons for the violation, time of the violation, and an advisory to avoid the violation, etc. The sensitive information, such as name of the driver, VIN number of the vehicle, plate number and address may be redacted from the ticket either manually by the user or automatically by the system. The questions or answers or comments category allows a user to ask any questions, input any answers, and input any comments related to traffic violations for the location in addition to viewing all this information contributed by other users. The traffic signs category allows the users to exchange information regarding traffic signs. Other categories not included in the above are added or deleted at the discretion of the administrator of the system. When a user has an inquiry regarding traffic violation related information for a location, the mobile application allows the user to post using the user engagement panel function to obtain more information. The user input information is open to comments and/or ratings from other users. The comments with the highest endorsements are given priority ranking for the position of the comment either at the top or the bottom of the list. If endorsements reach a certain amount then the user may receive a credit or reward. User engagement panel 134 may allow other users to provide various comments that include but are not limited to similar tickets and/or situations, dispute rates, and other information on whether a dispute may be successful based on provided circumstances from the user who received the traffic ticket.

The users may use user engagement panel 134 to post a picture of a traffic/street sign at a specific location, and ask about the plain language of the sign. The users often experience difficulty in understanding traffic signs, especially when there are multiple signs for different traffic rules. In addition, many drivers do not have a strong command of the English language or any other language that the sign is written in, which leads to further difficulties in interpreting the signs. Therefore, the mobile application may provide information in user engagement panel 134 on the specific location of the traffic signs and translate these traffic signs into easy-to-understand, plain terms. Since some traffic signs are confusing, the users participate in redesigning them to make new designs. The users create redesigns or translate traditional traffic signs to different languages to be more understandable. Their design images are subject to a rating system and the top design which generates the most positive ratings over a certain number after a certain amount of time may be rewarded. The top-rated design remains at the top of the list in user engagement panel 134 so other users can view and easily understand the meaning of the signs.

The system can also educate users on the process of disputing tickets if a dispute appears meritorious. It is often the case that users are unsure whether to dispute and how to dispute the ticket violation. The user utilizes crowdsourced ticket resolution information from other users to find out whether their ticket have a good chance of being dismissed if disputed based on information submitted by other users. The dispute procedures include information on the types of evidence that are collected and submitted to the proper authority who adjudicates the dispute. The user is also allowed to search and connect with third parties, such as lawyers who have registered with the system and who are experienced in disputing ticket violations. The mobile application allows the user to email pictures and other types of documents to the third-party directly from the mobile application. The mobile application's user engagement panel functionality also allows the users to share information on their hearing and results of their hearing for their tickets. The other users use this information as a reference for future hearings since the users are able to see other users who have gotten the same type of ticket in the same location for the same reasons. The system also uses this information to conduct analyses on locations that have unusual ticketing activity to initiate guidelines to the users.

The user supplements reported information with photos of the location and any written explanations in addition to the photographs in user engagement panel 134 connected to the location of the violation. If the user takes a picture of the ticket to upload to database 106, the mobile application allows the user to edit the image with an image editing function by covering/blurring information and/or sharpening the image prior to uploading the picture. The users cover/blur parts of the images with sensitive information, such as name, plate number, vehicle identification number etc. Using optical character recognition to sharpen blurry images increases the success rate for a computer to recognize the information in the image. As an alternative, the system can also allow a user to scan the traffic violation citation by utilizing a mobile device camera with scanner software downloaded into their mobile device.

Reported information is subject to a review and/or rating by the administrator of the system, and by other users to ensure that credible information is collected to provide notifications. The comments, suggestions, etc. may be listed in user engagement panel 134 according to ratings, and the ones with the highest amount of positive ratings can be listed at the top. The comments with the least positive ratings are listed at the bottom so other users can clearly view the postings to gain the best knowledge. Users are allowed to report to the system administrator any information they deem inaccurate. The system administrator is preferably able to open a case where an employee and/or a user will be sent to conduct an investigation of any purported inaccurate information to verify the information quality. The rewards are provided for the user of the mobile application who may have assisted in the investigation.

The notifications within the mobile application are short alerts stating the reasons why a user may have committed a traffic violation with brief information summarizing the historical violation data at the location. Notifications are preferably brief because users who receive them on their mobile communications device may be either driving to their intended destination and/or distracted from conducting other activities. The notifications alerting the users are generated based on the different categories, types of vehicles, and/or type of plate applicable to the user (e.g., the type of user) receiving the notification. One type of notification includes information about the potential violation such as dates and time frame applicable to the violation, if available, historical summary of violation citations at the current location, reason(s) for the violation, etc. The historical summary of ticket information contains a time frame from certain dates that are reflected in the data (e.g., date, month, time, etc.), traffic violation reasons, applicable penalties, total penalties collected, categories of ticket types and their applicable penalties, and the number of tickets issued within the time frame to educate the user and act as persuasive deterrence to inform the user of the potential consequences to prevent the user from taking a chance to perform the prohibited driving action at the location with previous violations.

The sharing of information triggers the application to send useful notifications to other user who benefits from the information based on their location(s) and/or circumstances. Therefore, when the system recognizes other users who are in the same location at the same time, the application can automatically provide a notification indicating important, resourceful information that includes the violation(s), specific reasons why there is a violation(s), any related penalties, alternatives to committing a violation, etc. For example, a user who constantly is driving over the speed limit and receiving tickets for speeding only benefits from the application's notifications if they were alerted of speed violations and also suggestions, advice, and/or solutions on how to avoid the same violation. For example, in New York City as of Nov. 7, 2014, the 25 mph default citywide speed limit will affect all streets where there is no posted speed limit. The existing “gateway” signs that read “NYC LAW SPEED LIMIT 30 UNLESS OTHERWISE POSTED” are changed to new signs that reflect the 25 mph default speed limit. Some larger streets, such as limited access highways or major arterial streets, have posted speed limits of 30 mph and above; these remain in place while DOT evaluates these locations. Some smaller streets where traffic calming measures have been implemented, like schools, are signed for speeds less than 25 mph. All streets that do not have a posted speed limit have a speed limit of 25 mph as of November 7. The general speed limit information is obtained through government websites, whereas the speed limit for particular streets is obtained through traffic citations, employees of the applications and the users' reports. The administrator looks into the information to see if there are any special reasons for the speed limit change. Once verified, the administrator is able to broadcast this information to users stating that the RRLC data has changed for this specific location. In addition, the system of the application now automatically sends notification alerts to users driving at 30 mph or 31 mph for that specific location depending on the user's preferences, since the new violation speed is posted at 32 mph. This applies unless there are special areas with especially low posted speed limits as further described below.

Another type of notification appears when the system displays a comparison of traffic rules applicable at different jurisdictions such as rules that apply at the current location and rules of the state that issued the user's driver license. The system may enable the user to view this notification information at any time by pressing a button on the screen of their mobile device 132 at the location to check for traffic violations or to check for differing traffic rules. The users may rate the information on the notification, and also report the notification to the administrator of the system if they think there is inaccurate or false information.

Exemplary embodiments of the inventive disclosure include a method and system of a mobile application for mobile device notifications in different situations. These notifications are generated from database 106 that involve the processing and analysis of several data set components: available historical and compiled data from informational sources, real-time data as crowdsourced from the user's inputted traffic violation related information, crowdsourced traffic violation dispute related information to assist/advise ticket disputes, rules and abbreviations data, traffic sign locations and traffic violation penalties data, ticket dispute data from the users, and any and all supplemental information as provided and/or verified by the administrator of the system, all of which are subject to review and/or ratings. The data is labeled in database 106 according to its source. The system may hire a team of professional individuals with relevant expertise in traffic violations and/or traffic rules to provide more accurate data for the database. The notifications are changed or updated depending on data gathered and the user reports.

Since notifications are short and meant to alert users with quick summarized information about potential traffic violations, the user utilizes the user engagement panel function to obtain more comprehensive and detailed information from user engagement panel posts, which may include inquiries, responses, discussions, pictures, videos, written descriptions, and any other information that is posted. While reported ticket text information is used to generate/update the content appearing in notifications, all of the information provided in ticket sharing goes to the ticket sharing user engagement panel (e.g., photos, videos, etc.). Users may access the user engagement panel and all its contents from the mobile application regardless of the user's current location while notifications are displayed only when the user is approaching the specific location(s) with previous issued traffic violation citations. Information provided by users through user engagement panels 134 can supplement and update information provided with notifications. The combination of receiving notifications and accessing user engagement panel 134 may provide more useful and extensive information for users because notifications provide quick, time sensitive information whereas user engagement panels 134 can provide more detailed, extensive information useful to gain full or better knowledge of a situation.

The time frame data is applicable to for example “No Left Turns, 7 AM-10 AM”, so any user whose geolocation data shows they are in that particular location receives a notification during the applicable time. The system connects with internal clock mechanism 216 of the mobile communications device 220 to send an automatic notification, reminding the user to that left turns are not allowed because the user is driving in that location within the hours of 7 AM through 10 AM. For quality control purposes, the system of the mobile application integrates a verification system. For rewards, the system tracks ratings so users only endorse one time for every ticket report. Additionally, a user only rates a notification of potential traffic violations if the user has firsthand experience of such traffic violation and received such notification when a user's geolocation was indicated to be within a certain distance or radius of, or predetermined region associated with the location with violations. Such geographic area is considered to be the impact zone, and generates the notification from the user who reported the traffic violation. Such users who have received the notification based on their firsthand experience can either endorse (positive) or rebut (negative) when rating the notification. These values are changed as necessary at the discretion of the user. Therefore, the application can display various route options for the user when the user searches for a route using a navigation function before they start traveling on the route and informs about traffic signs, applicable rules and red-light cameras along the way.

For example, truck routing in New York is highly regulated. The type of truck route that the user must take depends on the origin and destination of user's trip and therefore, classification of the truck type by the user is very important for the route planning. All vehicles defined as a truck (e.g., two axles and six tires, or three or more axles) are required to follow the Truck Route Network. Commercial vehicles that do not meet the definition of a truck are not required to follow this network, but must follow all posted signage regarding the operation of commercial vehicles. Both trucks and commercial vehicles cannot travel on most parkways in New York City.

The Truck Route Network is a set of roads that commercial vehicles must use in New York City. This network is comprised of two distinct classes of roadways, Local Truck Routes and Through Truck Routes. The network is defined in Section 4-13 of the New York City Traffic Rules. The Local Truck Route Network is designated for trucks with an origin and destination within a borough. This includes trucks that are traveling to make a delivery, or for loading or servicing. Trucks should only use non-designated routes for the purpose at the beginning or end of a trip, when traveling between their origin/destination and a truck route. The Through Truck Route Network is primarily composed of major urban arterials and highways and must be used by trucks that have neither an origin or destination within the borough.

For example, a truck trip that starts in Staten Island and ends in Queens would be required to use the Through Route Network while passing through the borough of Brooklyn en route to Queens. If the destination in Queens were not immediately accessible from the Through Truck Route, the driver would then have to travel on the Local Truck Route Network to complete his/her trip. However, a truck going from one end of Queens to the other is permitted to travel on the local truck route network. Manhattan and Staten Island contain Limited Truck Zones with special time and size restrictions.

In certain embodiments, the system may alert the driver in two ways. When using the navigation function to search for routing information to get to a certain destination, a user can enter relevant information to provide the user with navigation information that includes but is not limited to the height of the truck, the weight of the load on the truck, and whether the truck contains any goods that are subject to restrictions such as hazmat materials, etc. These values may be changed as necessary at the discretion of the user. Therefore, the Application may display various route options for the user when the user searches for a route using the navigation function before they start traveling on the route and informs about traffic signs, applicable rules and red-light cameras along the way. The various route options may indicate specific reasons why one route is better than the other (e.g., due to certain applicable restrictions on the route). Another way of alerting the user is when the user is a certain distance away from a location (e.g., bridges, tunnels, highways, etc.) that have special government restrictions for the type of vehicle the user is driving, the system may alert the user so the user can avoid this route, and more particularly, these locations if the user's vehicle does not comply with such restrictions.

When a user enters a start point and destination, they may be given several route options where they can then choose which route they would like to take according to whether it is the fastest route or whether the route has had less ticket violations by taking into account real-time traffic information. These options may be provided by tracking the both real-time traffic information and the history of violations in the area in database 106.

Optionally, a reward may be issued for the first user who reports ticket information at a location that has no prior ticket history of traffic violations in the database. The maximum amount the user receives may be the total amount stated on the user's ticket or any other amount that is set by the administrator of the system according to the amount of positive ratings received for providing ticket information along with comments and recommendations on how to avoid traffic violation citations. In this manner, users can potentially incur no losses (or substantially reduce losses) from ticket violations while educating others on how to better comply with RRLC data. The reward system involves several steps. To be eligible, a user is required to be the first user to fully report ticket information in detail for that specific location that did not have any prior ticket history by reporting the date and time of the issued ticket, with specific information on the reasons for the ticket, and also must give beneficial suggestions, ideas, and/or advice on how to avoid the same violation. Only the first user who shares the full details of the ticket information and receives a certain number of ratings may receive a reward. Any other users who try to report the same type of tickets at that location with the same reasons are notified that they do not qualify for a reward that is the same as the first user. However, the users are allowed to enter their ticket information if the ticket for the same location indicates different reasons/violations which may qualify for a reward. The mobile application allows a user to take a photo of the ticket, which is optionally edited before submission as described previously. Each location allows for the submission of one original ticket report which allows one user to gain a reward. However, the administrator of the system changes the type of reward and/or amount of reward to different users who report traffic ticket information by descriptions in different circumstances. For example, a reward for the first user pays double the amount of the reward or includes a gift as a monetary reward.

Ticket violations are legal documents subject to disputes. When a user wants to dispute a ticket violation, user engagement panel 134 and its functionality as described herein with respect to the particular location of the traffic citation is useful because the user can receive information from other users who comment on their personal situations with respect to citations they received at that particular location, and/or whether a dispute is likely to be successful or meritless. The system, using user engagement panel 134, crowdsources for traffic violation related dispute information from a plurality of users to assist the users with useful dispute information. This dispute information may also be useful for users who encounter a law enforcement officer, and use such information to discuss and explain the situation to them. The user may show the law enforcement officer that, in fact, other users who have received specific traffic ticket violation have disputed it in court and won. The law enforcement officer, now informed of the situation, may or may not issue the ticket violation or may revoke the ticket if the officer has the power to do so. This can save users money because if a dispute has merit as reported by others, the user has a chance to win the case. If the dispute does not have merit as reported by other users, then the user may decide to pay the fine and not dispute the ticket. Information related to disputes may be used to inform other users of ticket dispute probabilities. The administrator of the system may also hire professionals who specialize in traffic ticket disputes to assist in resolving dispute issues by communicating through user engagement panel 134. Information related to disputes may be used to inform other users of ticket dispute success probabilities. The system administrator may also hire professionals, who may specialize in traffic ticket disputes, to assist in resolving dispute issues through the user engagement panel 134. The application may allow a user to check dispute success probabilities through pressing a button on the display that connects to the database of traffic violation tickets received by other users. Accordingly, a user may be educated on any legal remedies available for such traffic violations.

Optionally, the mobile application allows a user to check dispute probabilities through pressing a button on a display of user engagement panel 134 that connects to database 106 which stores traffic violation tickets received by other users. Accordingly, users are educated on how to use legal remedies with efficiency. The system can alert the driver in two ways. When using the navigation function to search for routing information to get to a certain destination, the user can enter relevant information to obtain navigation information including, for example, the height of the truck, the weight of the load on the truck, and whether the truck contains any goods subject to restrictions such as hazmat materials, etc.

Some geographic areas are indicated as special speed zones with extremely low speed limits. Low speed limit zones are meant to increase safety by reducing opportunities for illegal speeding and aggressive driving. These zones can also enhance pedestrian comfort and the flow of traffic. For example, some geographic areas where a vehicle may only travel at 5 mph are indicated by extra-large signs with words in large font. The present system can be configured to send notifications to users for these special speed zone areas. To do this, the system can utilize images taken from sensors installed on the user's vehicle. The sensors capture an image of the sign, which indicates the speed applicable to the location where the vehicle is traveling. The image is uploaded to database 106 for processing and analysis. Once the image is processed by the system, it can automatically send notifications to a user regarding the low speed limit when the user is traveling towards or through the location.

In accordance with certain embodiments, another method for preventing traffic violations within a school zone relates to the existence of speed cameras within a school zone which are used to improve safety at schools with the highest accident rates. DOT examines accident histories around a city's (e.g., 1,471 elementary and middle schools), and works on new traffic and pedestrian signals, high visibility crosswalks, and other safety improvements. Many schools in New York conduct pre-school activities and/or after-school activities, and therefore, the general hours at which a school may operate may be from 6:30 AM to 7:00 PM. Since this is the time frame, the respective data regarding the applicable time frame may be input into a database. The speed limit for the school can also be input into the database. According to RRLC data in New York, the speed camera issues a ticket when the vehicle is traveling at 10 mph or up over the posted speed limit. A user may adjust the distance for the notification to alert him/her at a certain distance (e.g., 10 meters, 30 meters etc., beyond where the camera first captures its speed). As a result, a user does not have to worry about a stationary or mobile speed camera since the user is timely alerted to the applicable safe speed if they follow the information in the notification.

Most RRLC data states that a bike is considered a type of vehicle. Cyclists have all of the rights and are subject to all of the duties and regulations applicable to drivers of motor vehicles. Therefore, the systems and methods disclosed herein are applicable to users who travel by bicycle and motorcycle. Bicyclists are subject to traffic violations and may receive tickets based on these violations. If the user indicates in his/her profile settings that he/she is riding a bike, then the application can send the user notifications, alerting the user to areas where he/she must use the bike lane, stop at a stop sign, ride on the street, not on the sidewalk, use a white headlight and a red taillight, etc. The system may also be used as a reference for applicable bicycle rules for a specific jurisdiction. Additionally, the systems and methods disclosed herein are applicable to users traveling without vehicles, such as a pedestrian. Pedestrians are subject to traffic regulations and traffic-control signs. Such users can receive alerts for locations with pedestrian-related traffic violations, such as pedestrian jaywalking and tickets associated therewith.

Exemplary embodiments allow for direct integration of the disclosed traffic violation avoidance information system into a navigation and GPS System of an onboard computer of original equipment manufactured vehicles. In such embodiments, the disclosed architecture is integrated directly into a vehicle's computer system.

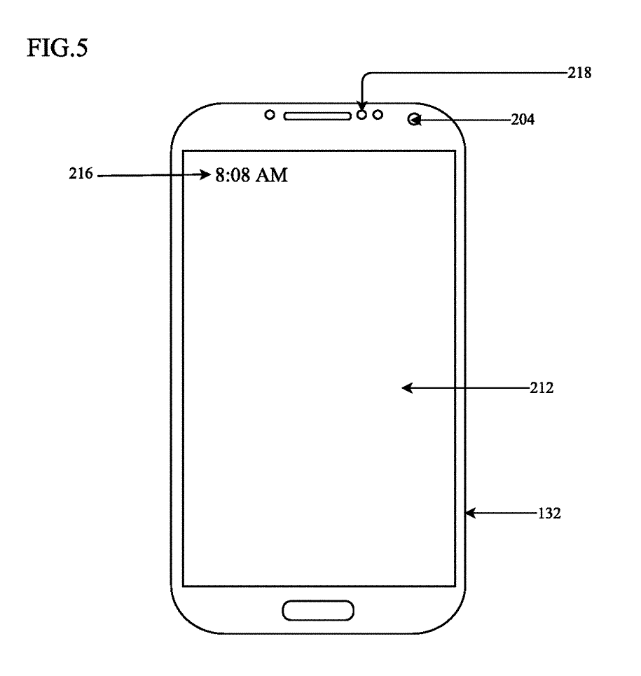

Referring again to FIGS. 1-4B with additional reference to FIG. 5, in view of the foregoing, a system for aggregating information between computing system 100 and at least one mobile platform or remote computing device 132 is depicted which provides notification of a potential traffic violation alert in a geographic area. Database 106 contains a plurality of traffic related data (FIGS. 4A and 4B) for at least one transportation vehicle or at least one pedestrian. The traffic related data includes historical traffic violation citations with traffic violation location information and real-time traffic violation citations. The traffic related data from the traffic violation citations may contain the following fields, by way of example, first name, last name, address, license state, registration expiration, time of violation, date of violation, law violated, description of vehicle, mph, mph zone, US Dot #, Place of occurrence, City of occurrence, county of occurrence, officers last name, officers badge number, police code, police agency, highway number, highway type, bus lane, hazmat violation, commercial vehicle. Mobile platform 132 may comprise location identifier 204 which provides location data. Location identifier 204 may be hardware resident on a mobile phone (as shown) or in the on-board computer of a vehicle. Mobile platform 132 is in communication with computing system 100 and further in communication with an accelerometer in a vehicle, for example, which provides acceleration data. The at least one mobile platform 132 provides at least one notification of a potential traffic violation alert for a geographic area according to the traffic related data, location data and acceleration data.

The accelerometer may be factory installed in a transportation vehicle such as a car. The transportation vehicle may also be a commercial vehicle, a non-commercial vehicle, a bicycle or a motorcycle. The at least one mobile platform 132 may be a mobile device and location identifier 204 and accelerometer 218 may be installed in the mobile device and in wireless communication with database 106. Database 106 residing in a central server may further contain traffic rules, temporary traffic notices, violation codes, and traffic signs for commercial and non-commercial vehicles, pedestrians, bicyclists and motorcyclists, and the at least one notification of a potential traffic violation alert. The geographic areas associated with the traffic related data, location data and acceleration data are also stored in database 106, along with traffic rules, temporary traffic notices, violation codes, and traffic sign data for commercial and non-commercial vehicles, pedestrians, bicyclists and motorcyclists.

Database 106 residing in central server 124 and containing a plurality of traffic related data may be populated by receiving the historical data from at least one information source, such as public websites, government websites, receiving real-time crowdsourced data from a plurality of users, verifying accuracy of the historical data and the real-time crowd-sourced data, and removing duplicate traffic violation citations from the historical data and the real-time crowd sourced data. The term central server may include a network of servers, many servers and/or a cluster of a hundred or even thousands of servers. Mobile platform 132 may have display apparatus 212 and display at least one notification on the display apparatus. The computing device may also be a standalone PC with a monitor.

Exemplary embodiments of the inventive disclosure may incorporate a traffic sign database operatively associated with the user engagement panels. The traffic sign database can store traffic sign information such as locations, images, and applicable rules, and can store temporary traffic notices applying to particular locations. Preferably, users of the systems disclosed herein can connect to the user engagement panels to clarify the meanings of the traffic signs. Traffic signs which apply to a user's current location may be automatically displayed for the user on the user's computing device (e.g., on a remote mobile computing device such as a handheld mobile device, smartphone or other computing device, or on an in-vehicle navigation system or computing device installed in the vehicle, or any other means of access such as a laptop computer, etc.) prior to, during, or after a user travels through a particular location. If the user does not understand the signage or has questions, the user may select the image of such signage on a display on the user's computing device to open the user engagement panel function. The user may report signage information and view any exchanged information from other users for this signage which is connected to the user's current location. It will be understood by one of ordinary skill in the art that “user engagement panel” as described herein is used to denote any type of panel, interactive display, or voice activated/operated module accessible by the user which allows the user to provide or exchange traffic violation related information. In certain embodiments, the system issues an alert to the user in advance, detailing the reasons for prior traffic violations applicable to vehicles having a same type of vehicle or vehicle-plate as the one driven by the user during the user's approach to an intended location associated with one or more issued traffic violation citations and/or one or more traffic laws, rules, or regulations.

Different issuing authorities may have different rules and regulations that apply only to the vehicles they have the authority to regulate. Accordingly, violation citation data may be categorized based on type of vehicle and/or type of vehicle plate to provide an accurate notification to a user based on user type. This categorization may be applicable to both commercial and non-commercial vehicles. However, certain law enforcement may have the authority to regulate and issue traffic citations for all types of vehicles. Accordingly, a notification may apply to all types of vehicles or all type of vehicle plates, or selectively to different types of vehicles and/or different types of vehicle plates. Also, different traffic violation related notifications may apply in different situations. A notification may be generated based on data retrieved from the database that involves the processing and analysis of several data set components, such as rules and abbreviations data, traffic control device locations and other related traffic signage information, ticket dispute data from a user, and all supplemental information as provided and/or verified by the system administrator, all of which may be subject to review and/or ratings.

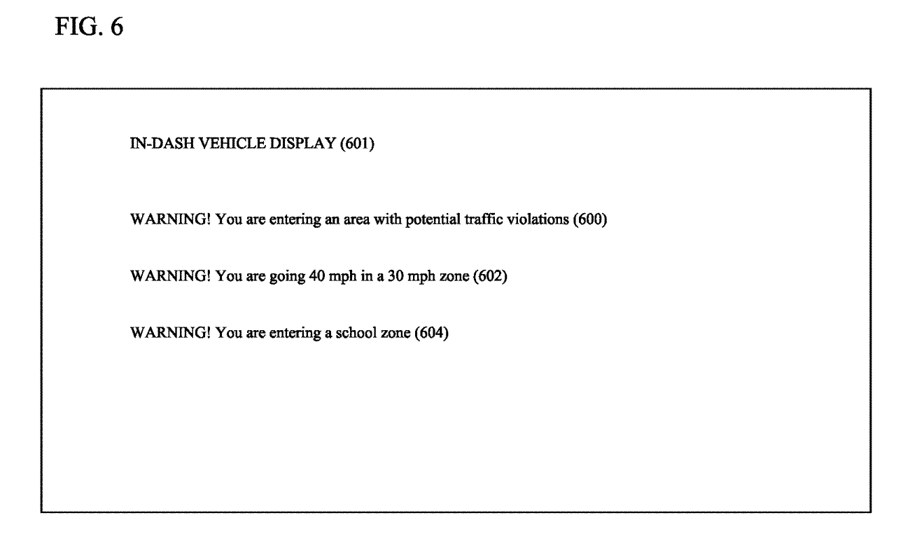

Turning now to FIG. 6, notifications or alerts may be shown to a user on an in-vehicle display, and/or on a display of user engagement panel 134 of a user's remote mobile device 132. Such in-vehicle display and/or mobile phone display may be similar and interchangeable, and may be displayed on one or both. While users preferably do not use mobile devices while driving, it may be useful for a passenger to receive notifications and the in-dash display. In this manner, a passenger can assist a driver to avoid potential traffic violations. Mobile platform 132 may be in communication with in-dash vehicle display 601, and provide at least one notification of a potential traffic violation alert regarding a geographic area (such as the user entering an area with potential traffic violations 600, the user driving 40 mph in a 30 mph zone 602, or the user entering a school zone 604) on in-dash vehicle display 601. Communication between system components may be in any form, and it will be understood that many forms of communication and technology may evolve to change the forms of communication without departing from the inventive disclosure. Display apparatus 212 associated with mobile platform 132 may display a comparison of traffic rules for different countries, states, cities, or municipalities. The comparison may be based on a current location of the transportation vehicle or other identified location information input into mobile platform 132 and a location obtained from a user's driver license stored in a user profile. Information obtained from the user's driver license may indicate a country, state and city of issuance of the user's driver license. The stored traffic rules are summarized, compared and analyzed to notify the user about differences between traffic rules of the country, state, and city mentioned in the user's driver license and the determined location of the transportation vehicle. The differences between the traffic rules may be displayed on one or more display apparatus.

Mobile device 132 may have internal clock mechanism 216 to identify a current time and date. Traffic related data stored in database 106 may further include at least historical traffic violation citations with time and date information. The at least one notification of a potential traffic violation alert (e.g., 600, 602 and 604) may occur according to the current time and date and the historical traffic violation citations with time and date information.

Mobile platform 132 may be an in-vehicle system with the location identifier an in-vehicle GPS navigation device and accelerometer in wired communication with at least one mobile platform having a location identifier. By way of example, each of these elements may be in the on-board computer of a vehicle. The vehicle may also have speed sensors for determining the speed of the transportation vehicle. The location identifier and the speed sensor are used to identify location and speed of the transportation vehicle and alert the user during driving within a predefined radius of one or more locations, or within predetermined distances of regions associated with the one or more locations with speed limitations. The locations with speed limitations may be identified through different indicators. Typically, a vehicle would have the GPS navigation device, accelerometer, and speed sensor, factory installed. However, this is not required. For example, navigation devices may be free standing add-on devices without departing from the scope of the inventive disclosure.

The plurality of historical traffic violation citations comprises geolocations, reasons, time and date of an issuance of traffic violation citations, red light cameras, speed camera locations, bus lane locations, bus lane cameras and applicable penalty information, and other traffic violation related information. The traffic related data may include crowd sourced traffic violation citation data.

The at least one mobile platform 132 may cross-correlate an identified current location of the transportation vehicle with a time and a location of the historical traffic violation citations and traffic rules to predict a likelihood of receiving a traffic violation citation at the identified current location of the transportation vehicle at a particular time. As discussed above, the plurality of traffic related data in database 106 may also be divided into non-commercial vehicle and commercial vehicle categories, and further divided into different categories by the type of vehicle plate or type of vehicle. The at least one notification of a potential traffic violation alert further provides detailed reasons of violations and/or recommendations for avoiding the potential traffic violation applicable to a same type of vehicle plate or a same type of vehicle during the transportation vehicle's approach to an intended location associated with at least one historical traffic violation citations or traffic rule.

The at least one mobile platform 132 may further transmit traffic information over a display apparatus. The traffic information comprises a plurality of traffic rules and regulations and the historical traffic violation citation locations from database 106 for the current location of the transportation vehicle. Database 106 comprises information about the locations having one or more associated potential traffic violation alerts or notifications, the types of vehicles involved, the types of vehicle plates, and the fees associated with the traffic violation citations. Computing system 100 may further comprise a microprocessor and a server readable program storage medium. The program storage medium is non-transitory and tangible in nature, and embodies a program of instructions executable by the microprocessor to search and update the traffic related data for a geolocation and provide at least one notification of a potential traffic violation alert to assist a user in avoiding traffic violations.

Traffic violation alerts are displayed on the display apparatus. The system may designate traffic zones having a history of issued traffic violation citations as traffic violation citation zones for which notifications are issued. Such traffic violation citation zones may be identified on the display apparatus with at least one indicator. The system may allow a user to specify a predetermined distance or time in advance of the user entering the traffic violation citation zone to issue the notification or alert for the potential traffic violation. For example, the user may input into the mobile platform that they want to receive notifications 30 seconds in advance of (or 3 blocks away from) the traffic violation citation zone. The system may also accept from a user an override of a notification relating to at least one of a location, a geolocation, a time, a bus lane violation, a school zone violation, or any other potential notification. For example, a user may travel the same route every date and already be aware that he/she is entering a bus lane or a school zone, and would find it bothersome to be informed of this fact every day.

The historical traffic violation citation information, which includes historical and real-time traffic citation data from database 106, may be used to determine the lowest allowable speed limit for commercial or non-commercial vehicles at specific locations by analyzing historical and real-time speeding violations. A modifier may be accepted from a user in the mobile platform. The modifier is an amount below the lowest allowable speed limit that an alert is sent to the mobile platform of the user. Similarly, the traffic violation citation information (e.g., both the historical and real-time traffic citation data from database 106) may be used to obtain the highest allowable speed limit for commercial or non-commercial vehicles at specific locations by analyzing historical and real-time speed traffic violations and comparing this data to the current speed of the vehicle of the user before a notification is sent to the user. A modifier may be accepted from a user via the mobile platform. While users may preset and adjust the particular distance from a particular location at which notifications may be sent to the user before arriving at the location with potential traffic violations, the function is also applicable to presetting and adjusting the particular time where notifications may be sent. Users may select a pre-determined amount of time in advance for a notification to be sent before the user arrives at the location with potential traffic violations. The time may be calculated using both speed and distance to the location. The system may track the current location of the user through the GPS capability in the mobile computing device and ascertain the distance from the point of the current location to the location of the potential violation. The system may also calculate the speed of the vehicle in motion through the accelerometer and GPS capability of the mobile computing device. The speed and the distance may then be used to calculate the time it will take the vehicle to arrive at the location with the potential violations. Once the time is calculated, the user will be notified when the time matches the preset time the user has indicated in which the user would like to receive a notification before arriving at the location with potential violations. Additionally, this time calculation may be dynamic and change according to the relative speed of the vehicle, which may be subject to change while the user is driving.

Another aspect of the inventive disclosure is that the mobile platform may be voice activated, which may be important or necessary to avoid violating certain traffic laws, such as using a mobile device while driving in a manner which is non-compliant. Typically, the mobile platform would be activated by the user pressing an application on a mobile device or the on-board computer. However, it will be appreciated that the application may be launched by voice activated command.

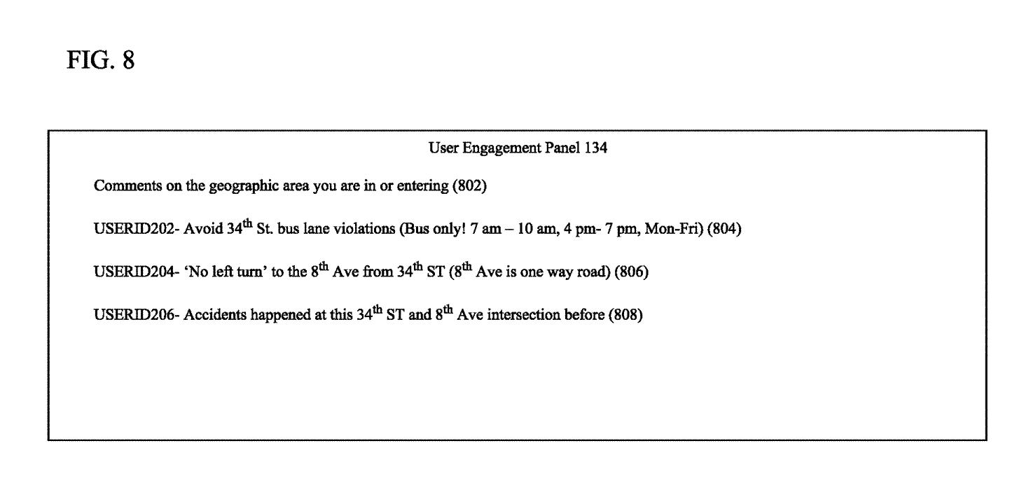

The at least one mobile platform 132 may have user engagement panel 134, which may contain a general user engagement panel for general information on ways to avoid traffic violations not connected to a specific location, and a specific user engagement panel connected to specific locations where traffic violations have occurred. The general user engagement panel may include a general discussion area for allowing the share and exchange of information and ideas about the traffic violation citations and avoidance thereof, and the general user engagement panel may be connected to the specific user engagement panel. User engagement panel 134 allows a plurality of users to exchange information and share ideas about traffic violation citations and avoidance thereof. For example, as shown in FIG. 8, user engagement panel 134 provides comments on the geographic area a user is in or entering 802, such as USERID202—Avoid 34th St. bus lane violations (Bus only! 7 am-10 am, 4 pm-7 pm, Mon-Fri) 804, USERID204—No left turn to 8th Ave from 34th ST (8th Ave is one-way road) 806, and USERID206—Accidents happened at this 34th ST and 8th Ave intersection before 808.

The specific user engagement panel is operatively associated with specific locations and is configured to organize content according to specific locations of the traffic violation citations, organize content to provide explanations of traffic signs, obtain suggestions to clarify the meanings of the traffic signs along with a rating corresponding to each suggestion, wherein the suggestions with top rating appear on top or the bottom of a list, gather questions, answers and comments about the traffic violations for the specific locations, organize content to clarify reasons for receipt of traffic violation citations; provide recommendations, share ideas, photos, videos, and provide comments to avoid traffic violation citations, organize content to provide plain explanations and multiple language translations of confusing traffic signs and obtain suggestions/redesigns of the confusing traffic signs to clarify their meanings, and provide a street view function with photos, comments, or videos for locations with patterns of traffic violations. The traffic violation alerts may be determined by combining a traffic advisory with a route plan the GPS navigation device or a mobile device enters a route planning mode through the input of an intended destination from a user, traffic violation citation data, traffic rules and regulations are retrieved from the database and advisory traffic alerts for potential traffic violation alerts are sent to the user along the route, and a route is provided to the GPS navigation device or mobile device to the intended destination with alerts of issued traffic violation citations based on the geolocation of the transportation vehicle.

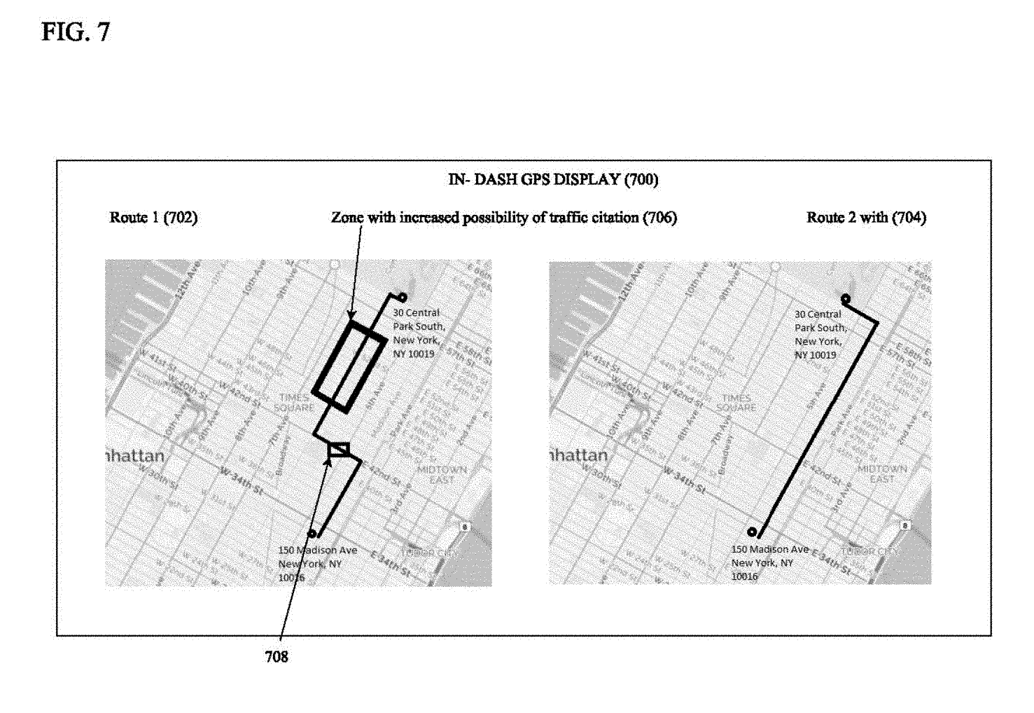

Turning to FIG. 7, which depicts in-dash GPS display 700 according to an exemplary embodiment of the inventive disclosure, one example of such route planning shows a first route (Route 1) from 150 Madison Avenue to 30 Central park South 702 having a zone with increased possibility of a traffic citation 706. An alternate route (Route 2) from 150 Madison Avenue to 30 Central park South 704 is provided, which avoids the zone 706 having the increased possibility of traffic citations.

In other exemplary embodiments of the inventive disclosure, school zone mapping may be provided wherein a predefined radius or distance from speed camera(s) 708 defines a school zone. For example, it may be known that speed camera(s) 708 is(are) located at 5th avenue and 42nd street as indicated in FIG. 7. System 100 may designate four blocks as the distance or region for a school zone. Speed camera(s) 708 may operate within a specific period of time before and after school is in session, such as from 7 am to 10 am in the morning and 2 pm to 4 pm in the evening. The applicable speed limit (e.g., 20 mph) for the school zone is stored in database 106. A vehicle whose geo-location indicates the vehicle is at any point within the predefined radius or distance of the school zone will receive a notification when the speed of the vehicle reaches a certain predetermined threshold determined to be a potential traffic violation (and thus warranting an alert or notification) when school is in session; and a vehicle whose geo-location indicates the vehicle is within a certain distance of the school zone. Such users will receive notifications when the speed of their vehicles reach a certain threshold that constitutes a potential traffic violation. School zones may be subject to at least one installed speed camera up to a predefined radius or distance from the entrance or exit of a school building indicated as a school zone. The speed camera may operate within a certain period of time before and after school is in session. The amount of time before and after school is in session may be adjusted to compensate for after school events activities. The applicable speed limit may be stored in the database. A vehicle with a geolocation that indicates the vehicle is at any point within the predefined distance of the school zone will receive notification when the speed of the vehicle reaches a certain threshold that may be a potential traffic violation; and a vehicle with a geolocation that indicates the vehicle is within a certain distance of the school zone will receive notifications when the speed of the vehicle reaches a certain threshold that may be a potential traffic violation. In certain embodiments, system 100 may be configured by a user (or generally) to refrain from issuing a notification when school is not in session (e.g., weekends, holidays, after hours, etc.).

In another exemplary embodiment of the inventive disclosure, system 100 may further determine a vehicle speed of the user at a specific location, compare the vehicle speed with the traffic data for a remote location that the user is approaching that is a predetermined distance away or a predetermined amount of time away in order to determine whether and when to send a notification to the user to alert him/her of the potential for receiving a traffic violation, such as for speeding.

System 100 may analyze historical traffic violation or citation data for a plurality of locations and infer or predict a speed at which a user is likely to receive a traffic violation or citation for such location. By comparing vehicle speeds at which citations are issued at a location with the actual speed limit for the location (e.g., stored as traffic data in database 106), system 100 can infer a speed, a minimum speed, or range of speeds likely to incur a citation at a given location, and base notifications on such inferences. Additionally or alternatively, system 100 may be configured to allow the user to manually preset when he/she wants to receive a notification that he/she is about to arrive at a location or region travelling at a speed likely to result in a traffic violation, and/or how much over the speed limit the user must be before receiving the notification. Such predetermined thresholds may vary depending on location and user preference. For example, the user may establish a preset preference that he/she wishes to be notified at least a predetermined amount of time before reaching such a location (e.g., at least 15 seconds, 30 seconds, 60 seconds, etc.), and/or a predetermined distance (e.g., 50 meters, 100 meters, 1 mile, etc.) away from such location. As the user is traveling along a route, system 100 may determine that the user is approaching a location at or above a predetermined threshold speed likely to incur a citation, and provide the user with a notification sufficiently in advance of the user arriving at the location based on the user's pre-set preferences for distance and time, to alert the user of the upcoming change in speed limit, and to warn the user to slow down. The notification may simply provide a warning, and may be provided visually or audibly.

The GPS may be used to help identify firsthand experience, which may be a personal experience of users whose geolocation history reflect they passed by locations with violations, or who have other knowledge of the traffic violation location within a certain distance of the traffic violation location wherein the firsthand experience may be verified. In this manner, the system can verify that “firsthand experience” information is verified. For example, the user may say, there is a cop pulling people over at 42nd and Fifth Avenue, the GPS may be queried to verify they were at (or within a certain distance of) that location. If they were, the “firsthand experience is verified. The inventive disclosure provides methods for mapping historical traffic violation citation information and aggregating data related to the historical traffic violation citation between a computing system and at least one mobile platform and providing notification of a potential traffic violation alert in a geographic area.

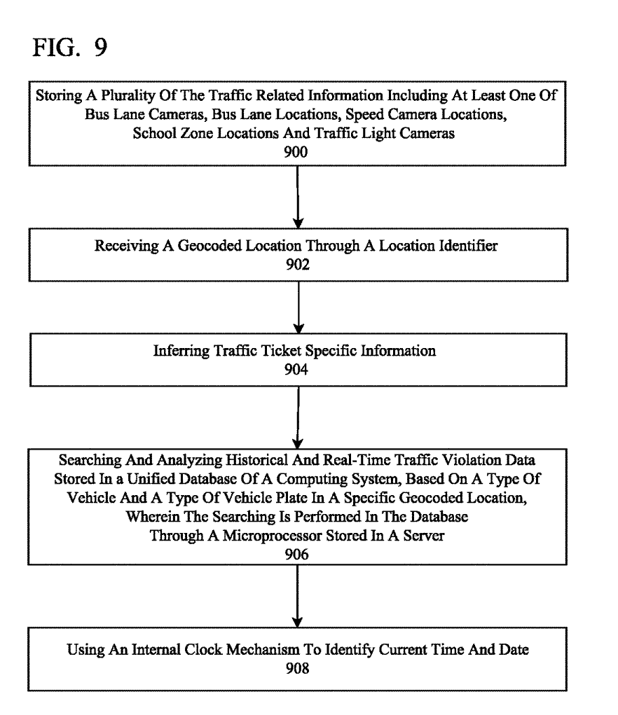

Turning now to FIGS. 9-14, shown are methodologies according to exemplary embodiments of the inventive disclosure. As shown in FIG. 9, such steps may include storing a plurality of traffic related information including at least one of bus lane cameras, bus lane locations, speed cameras locations, school zone locations and traffic light cameras (Step 900), receiving a geocoded location through location identifier (Step 902), inferring traffic ticket specific information (Step 904), searching and analyzing historical and real-time traffic violation data, stored in a database of a computing system, based on a type of vehicle and a type of vehicle plate in a specific geocoded location, wherein the searching is performed in the database through a microprocessor stored in server (Step 906), and using an internal clock mechanism to identify current time and date (Step 908).

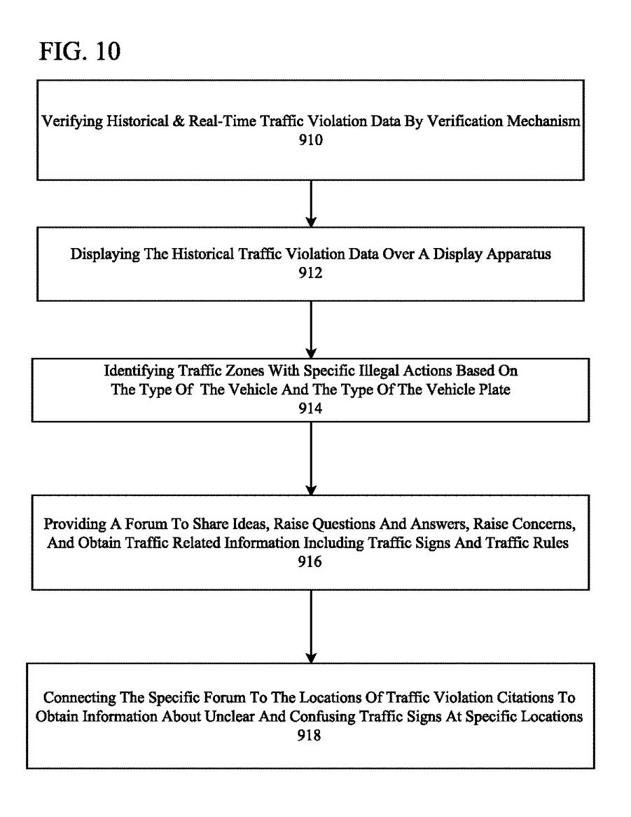

As depicted in FIG. 10, such steps may include verifying historical and real-time traffic violation data by verification mechanism (Step 910), displaying the historical traffic violation data over display apparatus (Step 912), identifying traffic zones with specific illegal actions based on the type of the vehicle and the type of vehicle plate (Step 914), and providing a user engagement panel to share ideas, raise questions and answers, raise concerns, and obtain traffic related information including traffic signs and traffic rules (Step 916), and connecting the specific user engagement panel to the location of traffic violation citations to obtain information about unclear and confusing traffic signs at specific locations (Step 918).

Traffic zones having a history of issued traffic violation citations are determined to provide traffic violation citation zones and the issued traffic violation citation zones are identified on a display apparatus with at least one indicator. The indicator may be a color on a map, a flashing symbol, a voice notification, a text notification, or any other manner in which an area may be indicated on a display device. The indicator may be based on the type of the vehicle and type of the vehicle plate. Different formats for the issued traffic violation citation zones may be displayed on an electronic map with location data through the display apparatus. The issued traffic violation citation zone indicators may be displayed dynamically. Different indicators may be used to identify, for example, (1) increased possibility of getting a traffic citation based on type of transportation vehicle and type of plate of the transportation vehicle, (2) density of issued traffic violation citations at specific locations for a specific type of transportation vehicle and type of plate of the transportation vehicle, wherein the density comprises a plurality of locations with higher number of issued traffic citations differentiated by different indicators including at least one of different colors and different shapes, (3) density of issued traffic violation citations for broad geographic areas and narrow geographic areas; (4) illegality of specific traffic actions within specific time frames, and (5) fluctuations in number of issued traffic violation citations reflected at specific locations based on a time and a date and historical traffic violation data for said location at the time of the day. The disclosed embodiment incorporates systems and methods to alert users about locations prone to violations by using different indicators that may include but are not limited to colors, shapes, formats or any other distinctive indicators to help the user identify potential violations while planning their route. Such locations are displayed on the display of the user through different indicators and may be applicable to certain points, streets or entire blocks. This feature is very useful for route planning, as it may help the users to avoid traffic violations by choosing alternative routes with no ticket violations or a smaller number thereof. Indicators may be changed dynamically, depending on the time of the day and day of the week according to the amount of issued traffic violations for the specific timeframe the user is planning his/her trip.

Database 106 may store a plurality of traffic rules, violation codes, historical traffic violation citations and real-time crowd-sourced traffic violation citations for commercial and non-commercial, pedestrians, bicyclists and motorcyclists, and other traffic related information, a plurality of issued traffic violation citations including geolocations, reasons and time and date of the issued traffic violation citations. An identified current location of a user may be cross-correlated with a time and a location of each of the issued traffic violation citations to predict a likelihood of receiving a traffic violation citation at the user's identified current location, time and date, wherein the at least one mobile platform further transmits traffic information over a display apparatus, wherein the traffic information comprises a plurality of traffic rules and regulations, locations with issued traffic violation citations availed from the database for current location of the transportation vehicle and traffic violation citation locations availed from the database for a location requested in the at least one mobile platform, wherein the traffic information further comprises a type of plate, a type of vehicle, and specific location of the issued traffic violation citation.

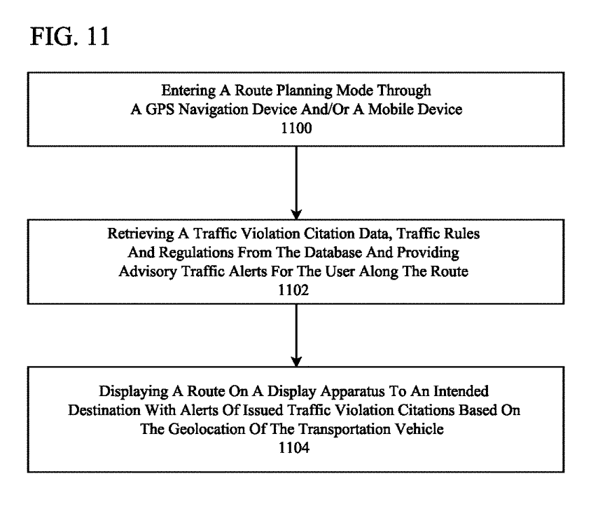

As shown in FIG. 11, the method may further comprise the steps of providing traffic violation alerts by combining a traffic advisory with route planning by performing the steps of: entering a route planning mode through a GPS navigation device and a mobile device (Step 1100), retrieving traffic violation citation data, traffic rules and regulations from the database and providing advisory traffic alerts for the user along the route (Step 1102) and displaying a route on a display apparatus to an intended destination with alerts of issued traffic violation citations based on the geolocation of the transportation vehicle (Step 1104).

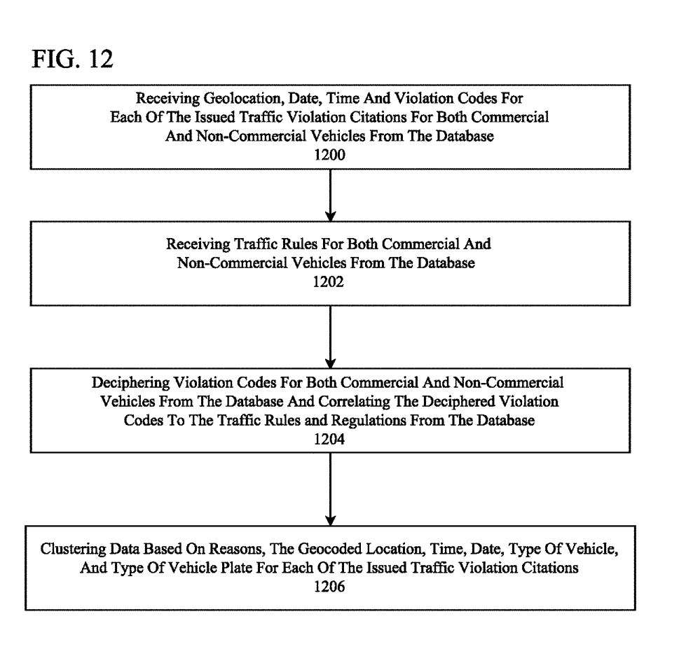

The microprocessor stored in the central server, to analyze and cluster the data, may perform the steps, as depicted in FIG. 12, including receiving geolocation, date, time and violation codes, for each of the issued traffic violation citations for both commercial and non-commercial vehicles from the database (Step 1200), receiving traffic rules for both commercial and non-commercial vehicles from the database (Step 1202), deciphering violation codes for both commercial and non-commercial vehicles from the database and correlating the deciphered violation codes to the traffic rules and regulations from the database (Step 1204), and clustering data based on reasons, the geocoded location, time, date, type of vehicle, and type of vehicle plate for each of the issued traffic violation citations (Step 1206).

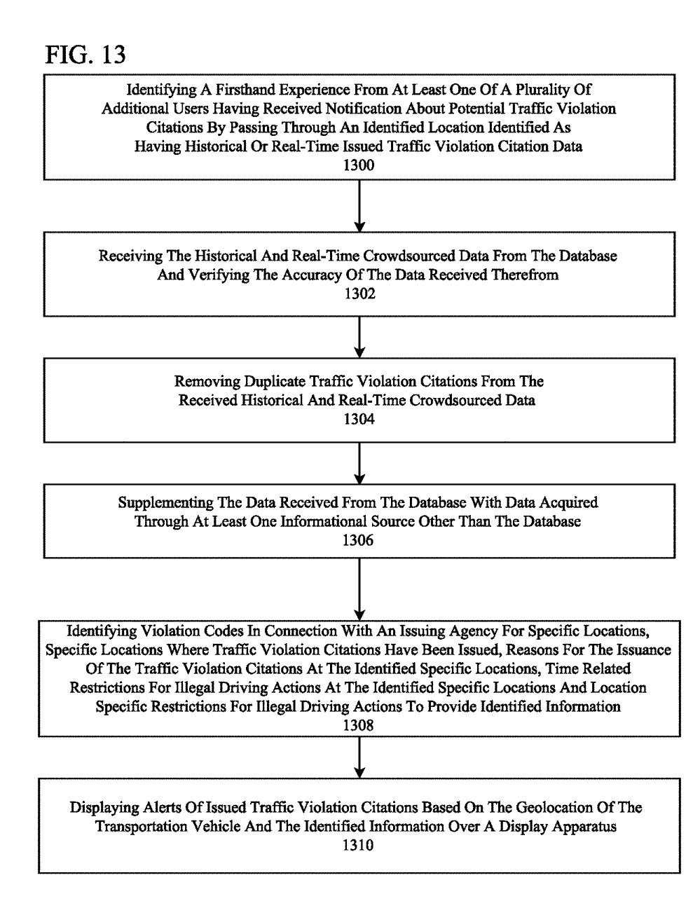

The methodology may also include, as seen in FIG. 13, the steps of identifying firsthand experience from at least one of a plurality of additional users having received notification about potential traffic violation citations by passing through an identified location identified as having historical or real-time issued traffic violation citation data (Step 1300), or receiving the historical and real-time crowd sourced data from the database and verifying the accuracy of the data received therefrom (Step 1302), removing duplicate traffic violation citations from the received historical and real-time crowd sourced data (Step 1304), and supplementing the data received from the database with data acquired through at least one informational sources other than the database (Step 1306). Additional steps may include identifying violation codes in connection with an issuing agency for specific locations, specific locations where traffic violation citations have been issued, reasons for the issuance of the traffic violation citations at the identified specific locations, time related restrictions for illegal driving actions at the identified specific locations and location specific restrictions for illegal driving actions to provide identified information (Step 1308), and displaying alerts of issued traffic violation citations based on the geolocation of the transportation vehicle and the identified information over a display apparatus (Step 1310). The historical traffic violation citation may be provided by photographs or scans of received traffic violation citations. An optical character recognition may be performed prior to providing the photographs or scans of the received traffic violation citations. The historical traffic violation citations may be input either manually or through interpreted vocal instructions into the database. The historical traffic violation citations may be input into the database, where updating and sharing leads to a monetary reward, credited to a user account on according to actions that may include at least one historical traffic violation citations data that is new for a specific location and not available through the database is shared and uploaded, at least one traffic violation citation that is new for a specific location is shared and uploaded with reasons for the traffic violation citations and recommendations are provided to avoid the violation citations, positive ratings received for provided recommendations from at least one user with firsthand experience, displaying the relevant data to alert a user and receiving a recommendation on how to avoid a traffic violation citation at a received geocoded location, where the recommendations can be rated either positively or negatively and providing the positive endorsements or ratings of the recommendation to avoid traffic violation citations by the one or more other users with firsthand experience, where an amount of the monetary reward may be equal to a total fine amount stated on a traffic violation citation, and where the monetary reward may be provided on reaching a predetermined number of positive endorsements or ratings.

In certain embodiments, the inventive methodology may include the steps of mapping and storing information in the database and alerting a user of certain time sensitive information related to violation locations; identifying the geolocation of the transportation vehicle by a location identifier; identifying current time by an internal clock mechanism; inferring a time sensitive data related to certain violation locations from the database; processing the bus lane data; displaying a bus lane zone on electronic maps in colors according to restrictions associated with the time of the day; and updating the database through historical bus lane citations, user reports and employees of the system.

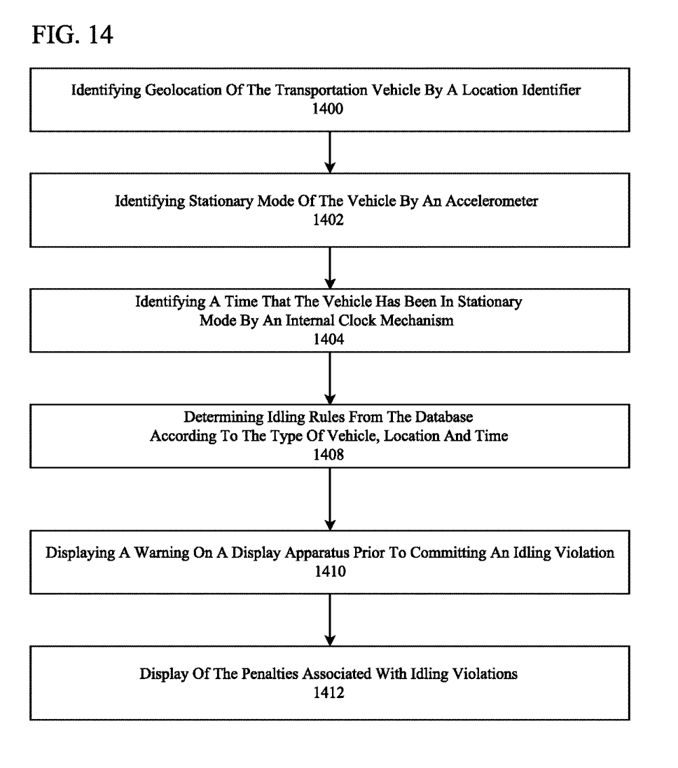

Additional steps may include, as shown in FIG. 14, identifying idling of the transportation vehicle by identifying geolocation of the transportation vehicle by a location identifier (Step 1400), identifying stationary mode of the vehicle by an accelerometer (Step 1402), identifying a time that the vehicle has been in stationary mode by an internal clock mechanism (Step 1404), wherein the internal clock mechanism starts tracking the time from beginning of the vehicle being in stationary mode, determining idling rules from the database according to the type of vehicle, location and time (Step 1408), displaying a warning on a display apparatus prior to committing an idling violation (Step 1410), and displaying the penalties associated with idling violations (Step 1412).

The idling rules may alternatively be inferred based on data stored in the database according to the type of vehicle, location and time. For example, if a ticket or citation is uploaded to the system for an idling violation, then the system may use the location identified on the ticket to infer that a certain location (i.e., a block or street) contains idling restrictions. Thus, once an idling ticket is reported for the location, the system can infer that the location stated on the ticket is a location that does not allow idling. Furthermore, in NYC for example, an idling violation is defined as having a vehicle's engine running while the vehicle is stationary for a period of three (3) consecutive minutes. Therefore, any vehicle which stops at that location in NYC for a period of time that is approaching 3 minutes (as calculated by the geolocation and a time mechanism), may be sent a notification from the system alerting the user to the possibility that the location is subject to an idling violation if the user continues to stay at that location. Idling rules are location specific. For example, as noted above, in NYC no person shall cause or permit the engine of any vehicle, other than a legally authorized emergency motor vehicle, to idle for longer than three (3) minutes unless the engine is being used to operate a loading, unloading or processing device. In school zones to cut pollution the law does not allow to idle for more than 60 seconds. Exemplary embodiments of the inventive disclosure utilize accelerometer, speedometer and the GPS to identify the location of the vehicle and the time that the vehicle has been in the idling state. The system will then generate an advance automatic notification to alert the driver he/she is approaching allowable idling time limits. The driver can then either take actions and shut off the engine or ignore the notifications, if he/she believes does not violate the rules.

System 100 may further verify whether there is duplicate data by sorting the data based on various criteria. The data can be sorted alphabetically by geolocations (A to Z or Z to A), numbers (smallest to largest or largest to smallest), dates and times (oldest to newest or newest to oldest), type of violation, etc. Such sorting may be customizable. Most sort operations are column sorts, but they can also be sorted by rows. Sort criteria are preferably saved as a worksheet in the database so that the system can re-apply the sort each time when new data is entered into database. If tickets issued on dates and times that match those which are already in the database and contain other matching information, such as the same vehicle and location, then this data may be labeled as duplicate data and rejected by system 100. However, tickets issued on dates and times not included in the database are added to the historical database and notifications are updated to properly reflect the added data to properly alert the users with the updated information.

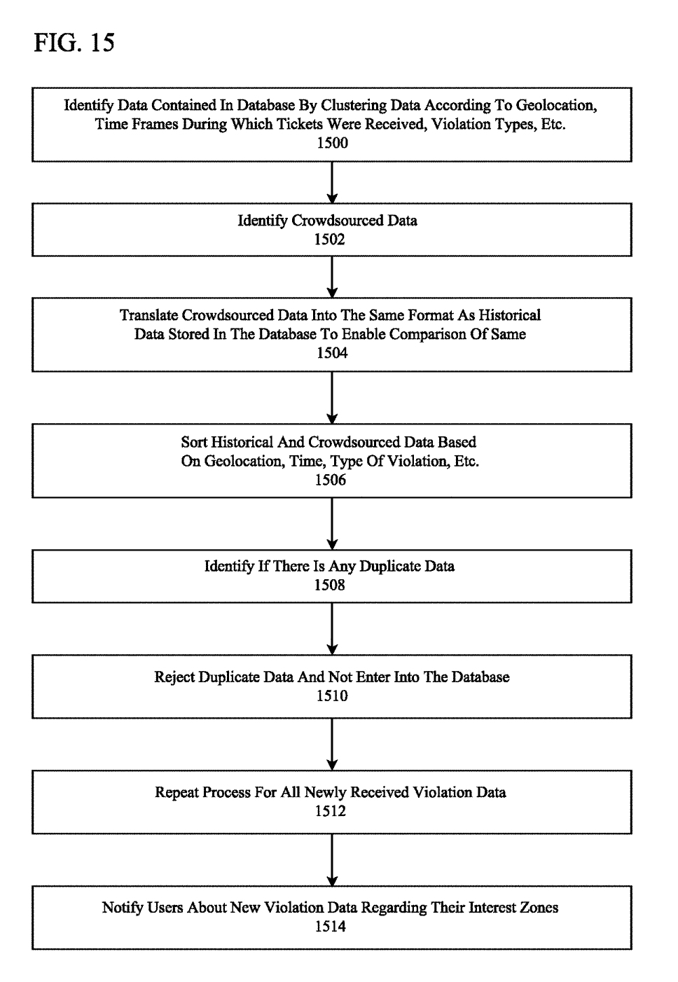

Referring next to FIG. 15, shown is a flowchart illustrating an embodiment of the inventive disclosure for identifying and/or verifying duplicative data. As depicted, the following illustrates one set of data verification steps. System 100 identifies data contained in database 106 by clustering the data according to, for example, geolocations, time frames during which the tickets were received, violation types, etc. (Step 1500), and identifies any crowdsourced data regarding the traffic violation data (Step 1502). To ensure that the crowdsourced data is accurate, it may be translated into the same format that matches the historical data contained in database 106 in order to enable comparisons (Step 1504). System 100 then may sort the historical and crowdsourced data based on geolocations, time, type of the violation variables, etc. (Step 1506), to identify if there is any duplicate data (Step 1508). If system 100 does find that data is duplicative, such duplicate data is rejected and not entered into database 106 (Step 1510). This process may then be repeated for every newly received violation data (Step 1512). Optionally, the users may be notified about every newly entered violations in their interest zones (Step 1514), such as geographical regions to which a user is interested in travelling, and/or geographical regions on a route of a user. Alternatively, users may customize when they wish to receive such updates.

In alternative embodiments, certain routes a transportation vehicle travels on frequently may be recorded, stored, and used to send notifications to the display apparatus when there are potential traffic violations on that route before the vehicle travels through this route. Such notifications may be sent to the display apparatus in real-time according to traffic violation reports from the database along the route that the vehicle is traveling on currently. System 100 may be configured to store traffic related data in database 106 which pertain not only to locations where users have been pulled over by law enforcement and issued citations, but also to the law enforcement personnel themselves, the users' experiences with them, and any information associated with these interactions. Such data may be crowd-sourced from various users through user engagement panels 134 of their remote computing devices 132 or in-vehicle navigation systems.

By way of example, traffic related data (e.g., 400, 402) in database 106 may include the exact location where a user first saw a police officer, the location where the user pulled over, the license plate of the squad car the officer was driving, a physical description of the officer, the officer's badge number and name, his/her demeanor, the user's synopsis of what was said and what transpired at the scene, the user's opinions as to the officer's temperament and what approach might be best for communicating with the particular officer, etc. If a particular user argues with a police officer and is subsequently issued one or more additional citations for purported traffic violations not initially mentioned by the officer (e.g., possibly as retaliation and/or because the officer did not like being crossed or challenged), then the user might note this information and upload it to system 100 after the interaction as crowdsourced citation data (406, 414). A particular officer might be prone to issuing specific types of tickets (e.g., speeding, improper lane change, no blinker, unusual or less common tickets, etc.), and a user may feel that one or more of the violations cited by the officer was inaccurate and/or unfair (e.g., that the user's alleged speed is significantly higher than the actual speed the user was going). All of this information may be input by the user through user engagement panel 134, during or after the interaction, and may be verified through crowdsourced ratings by additional users as described above. In particular, additional users who have encountered the same police officer and/or were pulled over at or near the same location may rate such office or citation data. System 100 may also be configured to collect, store, and categorize information for each officer in database 106, and to identify the types and patterns of citations issued by individual officers and/or by officers in particular geographic areas.

When a user is pulled over, if he/she can see the license plate number of the squad car, then he/she may input the plate number into system 100 before the officer approaches his/her vehicle. System 100 may be configured to then retrieve any information associated with the squad car based on the license plate, as well as the police officer(s) associated therewith. System 100 may display or otherwise communicate this information and/or a summary thereof for the user, or convey the information audibly to the user. It will be appreciated that system 100 may similarly retrieve such information based on the officer's badge number. In other embodiments, system 100 may be configured to similarly retrieve such information by predicting by inference which officer has pulled the user over based on the user's location (as identified by location identifier 204 of remote computing device 132), the time of day, and the traffic related data stored in database 106 for the particular day and time. System 100 may additionally or alternatively provide the user with a summary of historical citation data (e.g., recent data such as citations issued in the past few weeks or months) associated with that location, and display the information on user engagement panel 134 using remote computing device 132 or an in-vehicle display.

Additionally, the traffic related data stored in database 106 may include, for the particular location or geographic region where the user is pulled over, information as to any applicable traffic rules or laws which need to be observed. User engagement panel 134 may include a button (e.g., mechanical or touchscreen) on a display thereof specifically designed for a “pullover incident”. When a user first sees flashing lights of an officer's vehicle and interprets this to apply to him/her, the user may push the button on user engagement panel 134. System 100 may be configured to identify the user's location using location identifier 204, and access database 106 to retrieve any pertinent traffic and/or historical citation information based on the user's identified location. System 100 may then display a notification on user engagement panel 134 to inform the user of any appropriate traffic law information with which the user must comply when pulling over to avoid incurring any additional traffic violations (e.g., in addition to the traffic laws the officer believes the user has already violated). Such traffic law information may include, for example, “traffic signal required to change lanes”, “no U-Turn”, “no left turn”, etc.

Optionally, once the “pullover incident” button is activated by the user, system 100 may make an inference, as described above, as to which officer has instructed the user to pull over. Based on this inference, system 100 may provide one or more notifications to the user while the user is pulling over and/or while the user is waiting for the officer to approach the user's vehicle. The notifications may be based on the particular officer that system 100 has inferred to be associated with the pullover incident, and/or based on patterns of tickets issued in a geographic area within a predetermined distance of the identified location of the user. For example, if a number of prior users have been issued “unsafe lane change” or “failure to use turn signal” tickets within five miles of the identified rural location, at a particular intersection on a city block, or by a particular officer on duty in the area on a particular date and during a particular time period, then system 100 may be configured to provide a warning/alert to users approaching that area. Additionally, system 100 may be configured to warn a user who has activated the “pullover incident” button to be careful changing lanes, use his/her turn signal, watch his/her speed, etc. The notifications may be displayed over user engagement panel 134 on remote computing device 132, on an in-vehicle display, or by voice communication. System 100 may also be configured to provide the notifications in the form of an advisory as a user approaches an area where a predetermined number of traffic citations have issued over a predetermined time period. In this manner, system 100 can issue customizable notifications which help users avoid traffic violations before, during, and after a pullover incident.

System 100 may additionally or alternatively be configured to provide instructions to users who are nervous, unaccustomed to dealing with police officers, and/or who have particular attributes about themselves or their vehicles which could cause problems, such as a licensed firearm, a medical condition, illness, hearing difficulties, car defect, etc. The user's profile information stored as user data 432 in database 106 may contain this information, and may be utilized to formulate the instructions, which may include, for example, “put on your right blinker and pull over slowly to the right,” “do not block the shoulder,” “if your licensed firearm is in the vehicle glove compartment, be sure to indicate this to the officer before retrieving your insurance or other paperwork”, etc. System 100 may suggest that the user check his/her paperwork to ensure it is not a parent's or spouse's (e.g., if the user is borrowing the car), not expired, etc., to help the user avoid providing false or expired paperwork to the officer. Additionally, if the user is at a location where stopping could be dangerous for the user and/or the officer (e.g., on a bridge), the instructions may inform the user to “take the next exit 1000 feet ahead” or to “not pull over at your present location unless specifically instructed. Instead, pull over to the right after you pass under the bridge just ahead.” The instructions may also advise the user to retrieve his/her license and registration before the officer approaches the vehicle, and that once the officer approaches the vehicle, to keep his/her hands in front of him, to not make any sudden movements, to politely address the police officer, etc. Such instructions may help the interaction proceed more smoothly and avoid any escalation. All such notifications may be displayed or otherwise presented to the user via user engagement panel 134 or by voice activation.

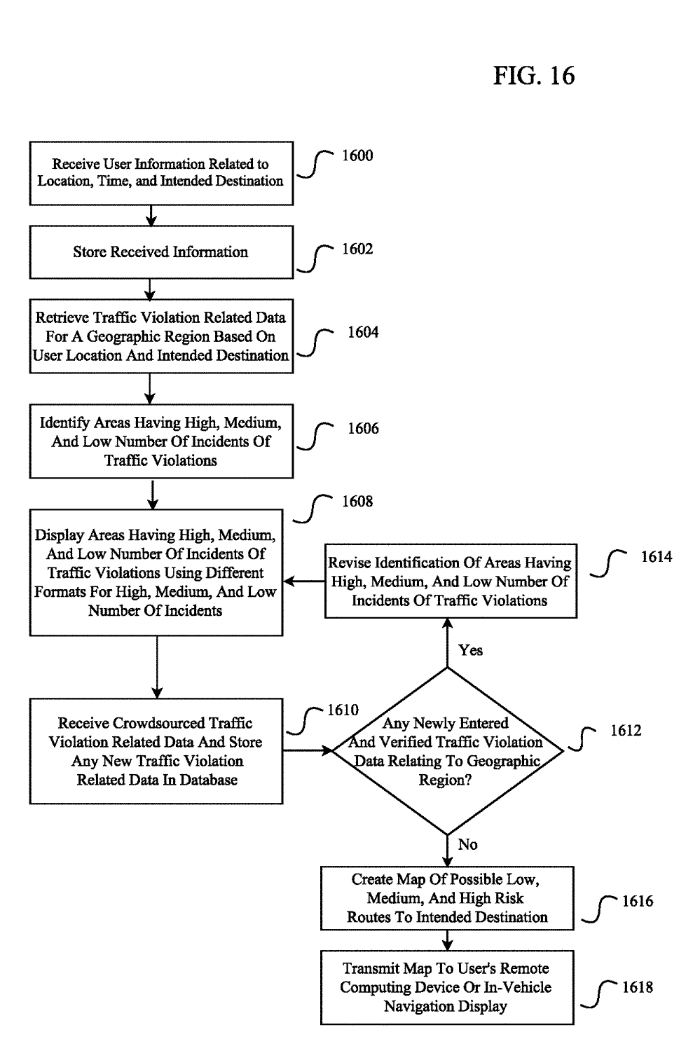

Turning next to FIG. 16, shown is a flowchart illustrating a method of informing a user of potential pitfalls in locations near and around a geographical area between a user's current location and an intended destination. System 100 may be configured to inform a user, for example, either a stationary user who is ready to start his/her trip or a user already in route to his/her destination, of any potential pitfalls (e.g., areas associated with a high number of traffic violations, locations having poor signage, etc.) along possible routes he/she may take to the destination. System 100 receives user information related to the time, the user's location, the user's intended destination, etc. (Step 1600), and stores the received information in database 106 (Step 1602). System 100 then retrieves stored traffic violation related data for a geographic region between the user's identified location and his/her intended destination (Step 1604) to identify areas having a high, medium, and/or low number of incidents of traffic violations (Step 1606). Once identified, these areas having high, medium, and/or low number of incidents of traffic violations may be displayed to the user using different formats for each of the areas having high, medium, and low number of such incidents (Step 1608). System 100 may continually receive crowdsourced traffic violation related data regarding any of a variety of geographical regions or locations and store such new traffic violation related data in database (Step 1610). Periodically or continuously, system 100 checks database 106 to determine and identify any such newly entered and verified traffic violation data relating to a geographic region of interest to the user (Step 1612). If such newly entered traffic violation data is found (Yes, Step 1612), system 100 revises the identification of areas having high, medium, and low number of incidents of traffic violations in accordance with such new data (Step 1614). On the other hand, so long as no new data is detected (No, Step 1612), system 100 may generate a map identifying possible low-, medium-, and high-risk areas along various routes to the user's intended destination (Step 1616), and transmit the map for display on a user's remote computing device 132 or in-vehicle navigation display (Step 1618).

System 100 may optionally deploy different indicators (e.g., of varying color, symbol, number/letter, etc.) along the route to indicate areas of varying levels of prior citations, police presence, traffic law changes, rule changes, etc. Certain areas along a route may have unclear or minimal signage warning users of, for example, a change in the speed limit, no U-Turn, no lane change, etc. System 100 may warn the user via these indicators, before starting the trip, of the location(s) along the route the user can expect to encounter these potential issues. System 100 can again notify or alert the user as he/she approaches such area(s).

System 100 may generate a display for a user of a particular user type on user engagement panel 134 which includes one or more traffic violation zones corresponding to locations where traffic violations are likely to occur. For example, in a certain location, there may be a sudden downhill and/or distraction related to various aspects of the route (e.g., signage, scenery, etc.), causing the user to inadvertently speed up beyond the posted speed limit. A police officer may or may not be at such locations, but regardless, the excess speed may be dangerous, particularly in the winter time when a road has turns and/or downhills. Database 106 can store information pertaining to such locations, and warn users about them via highlighted traffic violation zones. In other embodiments, the potential traffic violations may be specific to the user type, such as a bridge which does not allow certain types of commercial vehicles or trucks, or a lane which is for buses only. Such locations may have distractions or poor signage that a user may not see. System 100 may also preclude from any map or route plan certain areas, location, regions or zones where traffic violations are likely to occur.

The traffic violation zones displayed for the user on the display of user engagement panel 134 can be customized to the user's particular user type based on the historical traffic data in database 106 corresponding to the user's user type for that location. The traffic violation zones may include a single location on the user's intended route, indicated on the display by a first color (e.g., red), and a second color on portions of the route (e.g., green) which do not include the single location and which do not have a history of traffic violation citations and/or aspects thereof which may lead to traffic violations and/or citations. In other embodiments, the traffic violation zone may include two or more locations on the route, and the two or more locations may each be indicated on the display in red. The display may similarly include a green color on portions of the route which do not include the potential traffic violation locations. In yet other embodiments, a portion or portions of the route between two locations or leading up to them may also be indicated in red when a first location is less than or equal to a predetermined distance from a second location. In other words, if traffic violation locations are sufficiently close together, then the entire zone may be marked as red. In other embodiments, an entire geographic region may be marked in red if the region contains a predetermined number of recorded traffic violations over a particular time period.

A user may also be allowed to do a general search for potential traffic violations along a route using user engagement panel 134, and may further search for potential traffic violations based on user type, type of vehicle, or type of vehicle plate. Different formats may be used to identify the density of previously issued traffic violation citations at specific locations. For example, the higher the density of issued traffic violation citations in any particular location, the darker the color. This format may be applied for both broad and narrow geographic areas, whether the area is a borough or a street. The format used can also identify a fluctuation in number of issued traffic violation citations based on the time of day. Different colors and/or shapes may be utilized, such as a solid think red line representing a high density of violations or a thin dotted red line representing a lower density of issued traffic violation citations. The formatting used may additionally or alternatively be customized based on the user type. For example, each type of user might view a different format related to the type of vehicle they are driving or the type of vehicle plate on the vehicle he/she is driving. By way of example, a user in a commercial vehicle such as a truck may see a green format for a particular location, indicating that his vehicle is allowed in a particular lane, while a user in a non-commercial vehicle may see a red color in the same location, indicating that the lane is illegal for him because that location is restricted for commercial use. Database 106 may be dynamically updated based on any changing conditions, and populated with such new information as discussed herein. To view this data on an electronic map display, a user may input a specific location along with the current time, a time frame, and/or a certain point in time or a period of time in the future, and be presented an electronic map on his/her mobile phone.

It is to be understood that the phraseology or terminology employed herein is for the purpose of description and not of limitation. Having described at least one of the preferred embodiments of the inventive disclosure with reference to the accompanying drawings, it is to be understood that such embodiments are merely exemplary and that the invention is not limited to those precise embodiments, and that various changes, modifications, and adaptations may be affected therein by one skilled in the art without departing from the scope or spirit of the invention as defined in the appended claims. Therefore, while the embodiments herein have been described in terms of preferred embodiments, those skilled in the art will recognize that the embodiments herein can be practiced with modification within the spirit and scope of the claims. Any exemplary embodiments described herein are merely illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims. The scope of the invention, therefore, shall be defined solely by the following claims. Further, it will be apparent to those of skill in the art that numerous changes may be made in such details without departing from the spirit and the principles of the invention.

What is claimed is:

1. A computer-implemented method for providing traffic violation avoidance guidance, comprising:
categorizing traffic data into at least one data type associated with at least one user, the at least one data type comprising at least one of: commercial vehicle, non-commercial vehicle, vehicle type, vehicle plate type, motorcycle, bicycle, or pedestrian; and
providing at least one notification of a potential traffic violation based on (i) a location of a user; and (ii) the traffic data corresponding to the data type associated with the user.

2. The method according to claim 1, wherein the traffic data includes at least one of a traffic violation citation and one of: a traffic rule, a vehicle traffic rule, a motorcycle traffic rule, a cycle traffic rule, a pedestrian traffic rule, a temporary traffic notice, a violation code, or traffic sign content for at least one of a commercial vehicle, a non-commercial vehicle, a motorcyclist, a cyclist, or a pedestrian.

3. The method according to claim 1, wherein the notification includes at least one of a reason for a potential violation or a recommendation for avoiding the potential traffic violation applicable to the user based on the user type of the user during the user's approach to an intended location.

4. The method according to claim 1, wherein a user engagement panel is configured to allow at least one user to, for at least one specific location and at least one specific time or time frame:
provide content associated with traffic violations;
provide explanations of traffic signs;
obtain suggestions to clarify meanings of the traffic signs along with a rating corresponding to each suggestion, wherein the suggestions have a top rating appearing on top of a list;
gather information relating to the traffic violations;
provide content to clarify at least one reason for receipt of the traffic violations;
provide responsive information relating to avoidance of the traffic violations;
provide at least one of: plain explanations, multiple language translations, or requests for redesign suggestions of confusing traffic signs to clarify their meanings; or
provide a street view to enable at least one of: photos, comments, or videos for locations having a predetermined number of traffic violations.

5. The method according to claim 1, further comprising:
receiving electronic information identifying a region associated with a speed camera;
defining the region as a school zone; and
receiving location data from a location identifier associated with a remote computing device of the user; and
generating a notification based on the location data as the user approaches the region,
wherein the notification includes at least one of a speed limit for the school zone or an applicable time period for the speed limit, and
wherein a time at which the notification is to be generated is based on a comparison of the location data with the electronic information.

6. The method according to claim 1, wherein the traffic data further includes crowdsourced traffic data,
wherein the crowdsourced traffic data is obtained by an additional user providing the traffic data through a remote computing device, and
wherein the traffic data is modified based on the crowdsourced traffic data.

7. The method according to claim 6, wherein the additional user utilizes a user engagement panel to provide the crowdsourced traffic data, and
wherein the crowdsourced traffic data is subject ratings.

8. The method according to claim 6, further comprising:
subjecting the at least one notification to positive ratings or negative ratings by at least one of a plurality of additional users having firsthand experience,
wherein the positive or negative ratings are provided through at least one of a plurality of remote computing devices, and
wherein the firsthand experience is identified by the plurality of additional users passing or having passed within a predetermined distance of the location.

9. The method according to claim 8, further comprising:
providing a monetary or non-monetary reward to the additional user providing at least a portion of the crowdsourced traffic data associated with the notification, based on the notification receiving a predetermined number of the positive ratings.

10. A computer-implemented method for providing traffic violation avoidance guidance, comprising:
categorizing the traffic data into at least one user type comprising at least one of: commercial vehicle user, non-commercial vehicle user, vehicle type user, vehicle plate user, motorcyclist, cyclist, or pedestrian; and
providing at least one notification of a potential traffic violation based on (i) a location of a user; and (ii) the traffic data for the user type of the user.

11. The method according to claim 10, further comprising:
providing a summary of differences between a first plurality of traffic rules associated with a first location and a second plurality of traffic rules associated with a second location,
wherein the summary is based on at least one of the at least one user type.

12. The method according to claim 11, further comprising:
providing a notification, through a remote computing device, relating to at least one of a reason or a recommendation for a potential traffic violation at the first location or the second location.

13. The method according to claim 10, wherein the at least one user type corresponds to at least one data type,
wherein the at least one data type comprises one of commercial vehicle, non-commercial vehicle, vehicle type, vehicle plate type, motorcycle, bicycle, or pedestrian.

14. The method according to claim 10, wherein the traffic data includes at least one traffic violation citation comprising at least traffic violation location information.

15. The method according to claim 10, wherein the traffic data further includes at least one of real-time crowdsourced traffic data or historical traffic data,
wherein at least one of the crowdsourced traffic data or the historical traffic data is subject to ratings by at least one additional user, and
wherein the traffic data is modified based on at least one of the crowdsourced traffic data or the historical traffic data receiving a predetermined number of ratings.

16. A computer-implemented method for providing traffic violation avoidance guidance, comprising:
providing a computing system configured for communication with a user and a plurality of additional users through at least one user engagement panel associated with at least one remote computing device;
categorizing traffic data based on at least one of a user type or a data type;
identifying a location of the user using a location identifier in communication with the at least one remote computing device;
analyzing the traffic data to predict at least one potential traffic violation based on at least a location of the user and a user type of the user; and
generating at least one notification for the location based on the data type corresponding to the user type.

17. The method according to claim 16, wherein the data type corresponds to the user type, and
wherein the commercial vehicle data type corresponds to a commercial vehicle user type, the non-commercial vehicle data type corresponds to a non-commercial vehicle user type, the vehicle data type corresponds to a vehicle user type, the vehicle plate data type corresponds to a vehicle plate user type, the motorcycle data type corresponds to a motorcyclist user type, the bicycle data type corresponds to a bicyclist user type, and the pedestrian data type corresponds to a pedestrian user type.

18. The method according to claim 16, wherein the data type comprises at least one of commercial vehicle, non-commercial vehicle, type of vehicle, type of vehicle plate, motorcycle, bicycle, or pedestrian,
wherein the user type comprises at least one of commercial vehicle user, non-commercial vehicle user, user type based on type of vehicle, user type based on type of vehicle plate, motorcyclist, cyclist, or pedestrian, and
wherein the data type corresponds to the user type.

19. The method according to claim 16, further comprising:
identifying a plurality of specific locations along a route which, for a specific type of vehicle or a specific type of vehicle plate, have at least a predetermined number of issued traffic citations; and
displaying, on the remote computing device, a plurality of indicators corresponding to the plurality of specific locations along the route having at least the predetermined number of issued traffic citations;
storing, in the database, at least one route travelled by a vehicle at least a predetermined number of times;
determining, based on the traffic data, at least one potential traffic violation within a geographic region on the at least one route; and
sending a respective notification to a display apparatus of the remote computing device prior to the remote computing device entering the geographic region.

20. The method according to claim 16, further comprising:
identifying a fluctuation in a number of issued traffic violation citations at one or more specific locations along a route based on a change in at least one of time or date, and based on the traffic data stored in the database for the location; and
displaying, on the remote computing device, an indicator representative of the fluctuation at the specific location.
